(19) United States
(12) Patent Application Publication
(10) Pub. No.: US 2016/0356615 A1
(43) Pub. Date: Dec. 8, 2016

(54) Scheduled and On-Demand Transportation Management Platform for Rideshare

(71) Applicant: MuV Technologies, Inc., Monte Sereno, CA (US)

(72) Inventors: Barry Arata, Monte Sereno, CA (US); Stephanie Arata, Monte Sereno, CA (US); Brad McGibben, Santa Cruz, CA (US); Markus Tarkiainen, Half Moon Bay, CA (US)

(21) Appl. No.: 15/174,882

(22) Filed: Jun. 6, 2016

Related U.S. Application Data
(60) Provisional application No. 62/171,942, filed on Jun. 5, 2015.

(51) Int. Cl. G01C 21/34; G06Q 50/30; G01C 21/36

(52) U.S. Cl. CPC G01C 21/3438; G01C 21/3676; G06Q 50/30

(57) ABSTRACT

A system and method that performs ridesharing. The method includes identifying a plurality of users as a group; receiving profile information to identify drivers and passengers; receiving trip details from a driver; receiving a passenger request from a passenger; performing a ride match to match the driver and passenger based on the trip details and the passenger request; and providing the ride match to the driver and the passenger.

### CROSS REFERENCE TO RELATED APPLICATIONS

The present application claims priority, under 35 U.S.C. §119, to U.S. Provisional Patent Application No. 62/171,942, filed Jun. 5, 2015 entitled “Scheduled and On-Demand Peer-to-Peer Rideshare,” which is incorporated by reference in its entirety.

### BACKGROUND

Field of the Invention

The specification generally relates to performing scheduled and on-demand ridesharing. In particular, the specification relates to a system and method for comparing routes from users and/or transportation program administrators and dynamically determining matches between the routes for ridesharing.

Description of the Background Art

Ridesharing is a method of travel where users share a vehicle in order to red vehicle trips, traffic congestion, and automobile emissions. Ridesharing is similar to carpooling in that empty seats in a vehicle are utilized by passengers. Types of transportation that are considered ridesharing include carpool, vanpool, shuttle and transit or public transport. Other names for ridesharing include Transportation Demand Management, Alternative Transportation, Active Transportation, and Mobility.

Current ridesharing techniques allow designated drivers to receive a notification that a user requests a ride and pick up the users, similar to a taxi service. Current ridesharing techniques match drivers with users based on which drivers are closest and available at the time the user submits the request.

Current ridesharing techniques do not provide a way to match users and drivers that are already traveling along similar routes. Current ridesharing techniques also do not allow users to organize ridesharing ahead of time; rather, current ridesharing techniques only allow organizing the ridesharing when the ridesharing is requested.

### SUMMARY

The techniques introduced herein overcome the deficiencies and limitations of the prior art, at least in part, with a system and method for performing ridesharing. In one embodiment, a system and method for ridesharing includes identifying a plurality of users as a group; receiving profile information for the plurality of users to identify a driver and a passenger; receiving trip details from the driver; performing a ride match to match the driver and the passenger based on the trip details and the passenger request; and providing the ride match to the driver and the passenger.

In another embodiment, a method for performing ridesharing includes receiving profile information from a plurality of users associated with a group; receiving a driver route from a first user of the plurality of users, the driver route including a driver parameter; receiving a passenger request from a second user of the plurality of users, the passenger request including a pickup location; determining a match between the driver route and the passenger request based on the driver parameter, wherein determining the match includes comparing the driver route to the pickup location and determining that the driver parameter is satisfied based on the driver route and the pickup location; and providing the match to the first user associated with the driver route and the second user associated with the pickup location.

Other aspects include corresponding methods, systems, apparatuses, and computer program products for these and other innovative aspects.

The features and advantages described herein are not all-inclusive and many additional features and advantages will be apparent to one of ordinary skill in the art in view of the figures and description. Moreover, it should be noted that the language used in the specification has been principally selected for readability and instructional purposes and not to limit the scope of the techniques described.

### BRIEF DESCRIPTION OF THE DRAWINGS

The techniques introduced herein are illustrated by way of example, and not by way of limitation in the figures of the accompanying drawings in which like reference numerals are used to refer to similar elements.

FIG. 1 shows a high-level block diagram illustrating one embodiment of a system for performing ridesharing.

FIG. 2 shows a block diagram illustrating one embodiment of a computing device including a ride match engine.

FIGS. 3A-3B show block diagrams illustrating one embodiment of a user profile module and a parameter module.

FIG. 4 shows a flow diagram illustrating one embodiment of a method for performing ridesharing.

FIG. 5 shows a flow diagram illustrating another embodiment of the method for performing ridesharing.

FIG. 6 shows a flow diagram illustrating another embodiment of the method for performing ridesharing.

FIG. 7 shows a flow diagram illustrating another embodiment of the method for performing ridesharing.

FIG. 8 shows a flow diagram illustrating one embodiment of a method for providing indications of vehicle locations.

FIG. 9 shows a flow diagram illustrating another embodiment of the method for performing ridesharing.

FIG. 10 shows a graphical representation of one embodiment of a user interface showing a driver profile.

FIG. 11 shows a graphical representation of another embodiment of the user interface showing a user profile.

FIG. 12 shows a graphical representation of another embodiment of the user interface showing the user profile.

FIG. 13 shows a graphical representation of another embodiment of the user interface showing trip details.

FIG. 14 shows a graphical representation of another embodiment of the user interface showing a driver route.

FIG. 15 shows a graphical representation of another embodiment of the user interface showing an agenda view of scheduled trips.

FIG. 16 shows a graphical representation of another embodiment of the user interface showing a passenger request.

FIG. 17 shows a graphical representation of another embodiment of the user interface showing a mapping of the trip.

FIG. 18 shows a graphical representation of another embodiment of the user interface showing ride matches.

FIG. 19 shows a graphical representation of another embodiment of the user interface showing trip details.

FIG. 20 shows a graphical representation of another embodiment of the user interface showing no driver matches.

FIG. 21 shows a graphical representation of another embodiment of the user interface showing pickup locations.

FIG. 22 shows a graphical representation of another embodiment of the user interface showing a calendar of trips.

FIG. 23 shows a graphical representation of another embodiment of the user interface showing passenger request details.

FIG. 24 shows a graphical representation of another embodiment of the user interface showing a mapping of the trip with an estimated arrival time.

FIG. 25 shows a graphical representation of another embodiment of the user interface showing a mapping of the trip with a vehicle location indicator.

FIG. 26 shows a graphical representation of another embodiment of the user interface showing a mapping of the trip.

### DETAILED DESCRIPTION

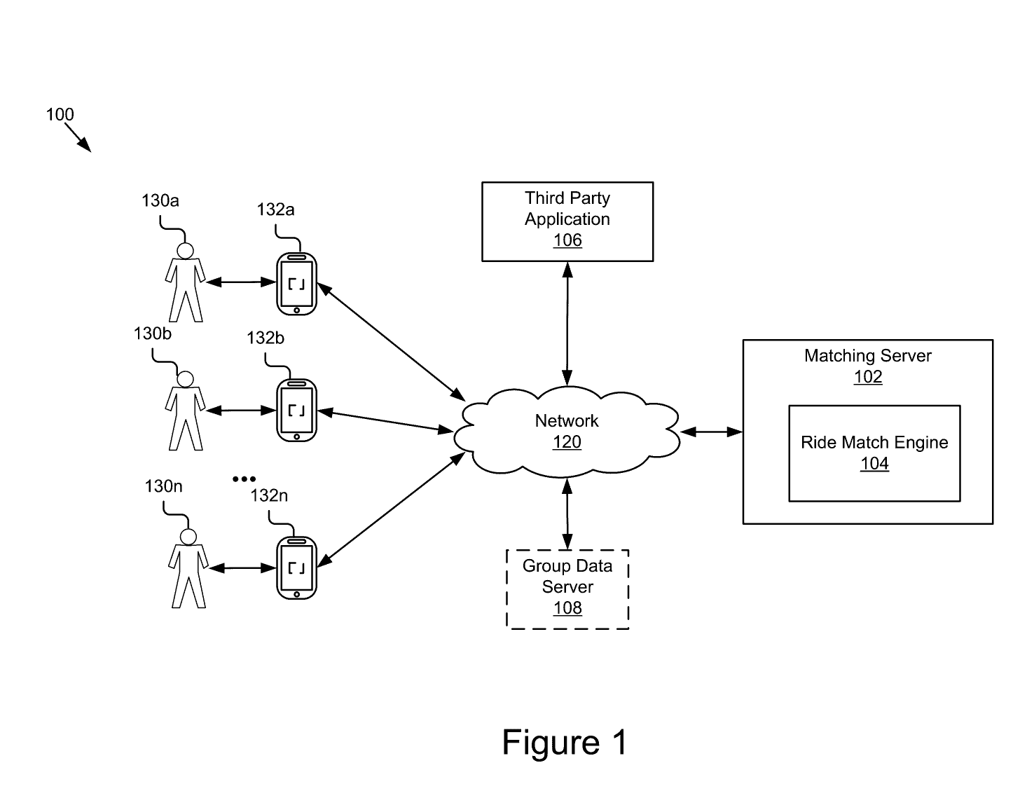

FIG. 1 shows a high-level block diagram illustrating one embodiment of a system 100 for performing ridesharing. The illustrated system 100 may have one or more client devices 132a . . . 132n that can be accessed by users 130a-130n and a matching server 102. In FIG. 1 and the remaining figures, a letter after a reference number, e.g., “132a,” represents a reference to the element having that particular reference number. A reference number in the text without a following letter, e.g., “132,” represents a general reference to instances of the element bearing that reference number. In the illustrated embodiment, these entities of the system 100 are communicatively coupled via a network 120.

In one embodiment, the matching server 102 performs ridesharing for the various users 130 using graphical user interfaces on the client devices 132. Ridesharing allows for users 130 to be matched up for ridesharing with other users along a route. In some embodiments, a user 130 may use a client device 132 to create a user profile in a graphical user interface on the client device 132. The user profile includes information related to the user. User profiles may include driver profiles for users 130 that have updated their user profiles to include driver information and passenger profiles for users 130 that have updated their user profiles to include passenger information.

In some embodiments, the matching server 102 is configured to receive trip details from a user 130 designated as a driver. The trip details may include a driver start location, a driver stop location, a one-way or round-trip designation, a date, an arrival time, a departure time, and/or a hot-spot location, as described elsewhere herein. The matching server 102 may use trip details to determine a driver route. In some embodiments, the driver route may be a shortest distance between the driver start location and the driver stop location as described elsewhere herein.

In some embodiments, the matching server 102 is configured to receive a passenger request for a user 130 designated as a passenger. The passenger request may include a pickup location, a drop-off location, a one-way or round-trip designation, a date, an arrival time, a departure time, and/or payment information. The matching server 102 compares the passenger request to stored driver routes to determine ride matches. Ride matches are driver routes and passenger requests that satisfy various parameters. For example, a driver route may have a parameter related to how many extra miles the driver is willing to deviate from the overall distance of the driver route to pick up a passenger and a ride match would be any passenger requests along the driver route below that parameter.

In some embodiments, the ride matches are provided to the passenger and the passenger can select to schedule a trip with a driver. The trip may then be scheduled and the driver will be alerted on their client device 132 of the upcoming ride share. By using the techniques described herein, a user 130 is able to connect with other users that are already planning to travel along a route and form a rideshare rather than having designated drivers that wait for a request for a ride to another location. In some embodiments, the ride matches are based on a variety of different ride types when comparing the passenger request. Ride types may include personal vehicles such as cars, trucks, SUVs, etc., public transportation such as buses, trains, ferries, etc., and/or personal transportations services such as van pools, taxis, park and rides, etc. The ride match is capable of incorporating existing information related to common transportation routes, such as bus schedules, and combine the common transportation routes with peer-to-peer ridesharing in order to provide a variety of ride matches to a passenger.

With respect again to FIG. 1, the network 120 can be a conventional type, wired or wireless, and may have numerous different configurations including a star configuration, token ring configuration or other configurations. Furthermore, the network 120 may include a local area network (LAN), a wide area network (WAN) (e.g., the Internet), and/or other interconnected data paths across which multiple devices may communicate. In some embodiments, the network 120 may be a peer-to-peer network. The network 120 may also be coupled to or include portions of a telecommunications network for sending data in a variety of different communication protocols. In some embodiments, the network 120 may include Bluetooth communication networks or a cellular communications network for sending and receiving data including via short messaging service (SMS), multimedia messaging service (MMS), hypertext transfer protocol (HTTP), direct data connection, push notifications, WAP, email, etc. Although FIG. 1 illustrates one network 120 coupled to the client devices 132 and the matching server 102, in practice one or more networks 120 can be connected to these entities.

In some embodiments, the system 100 includes a matching server 102 coupled to the network 120. In some embodiments, the matching server 102 may be either a hardware server, a software server, or a combination of software and hardware. The matching server 102 may be, or may be implemented by, a computing device including a processor, a memory, applications, a database, and network communication capabilities. In the example of FIG. 1, the components of the matching server 102 are configured to implement a ride match engine 104 as described elsewhere herein. In one embodiment, the matching server 102 provides services to the users 130 via client devices 132. While the examples herein describe ridesharing services for users 130, it should be understood that the matching server 102 may perform other matching functions via other types of devices.

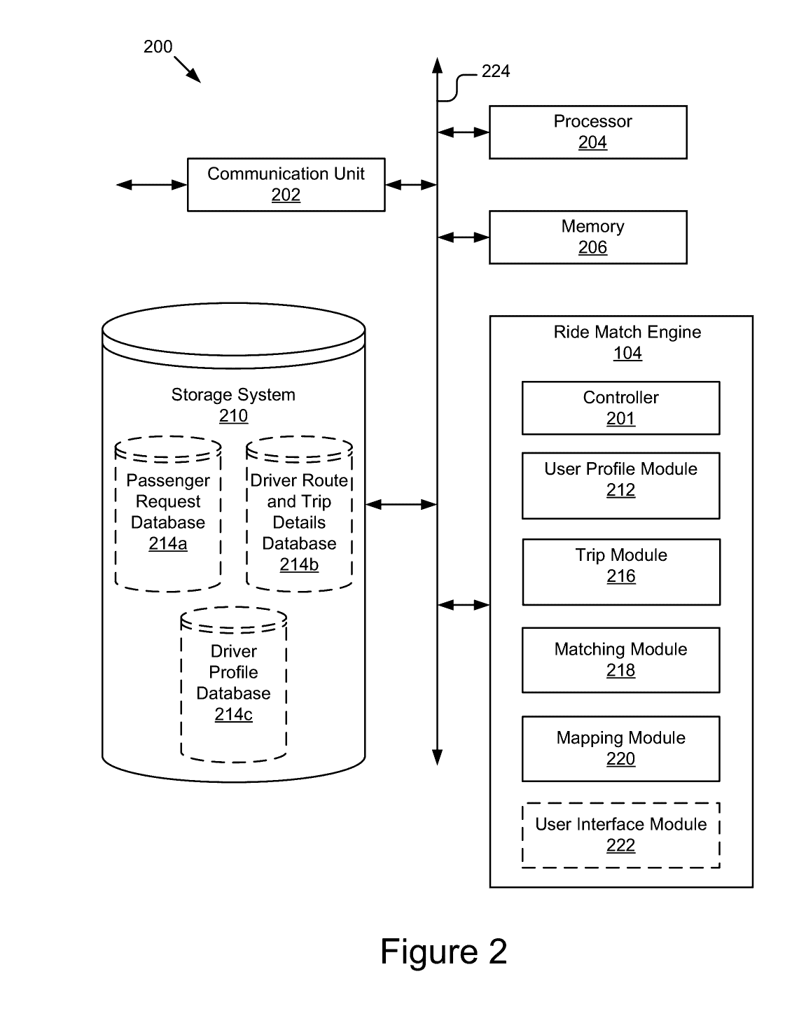

In some embodiments, the matching server 102 sends and receives data to and from other entities of the system 100 via the network 120. For example, the matching server 102 sends and receives data including user profile information or trip details to and from the client device 132. The information received and sent by the matching server 102 may include information entered by a user 130 via the client device 132, information retrieved from the group data server 108, information received from a third party application 106, and/or information stored in a storage system 210 by the matching server 102 or other components of the system 100. Although only a single matching server 102 is shown in FIG. 1, it should be understood that there may be any number of matching servers 102 or a server cluster. The matching server 102 may also include or have access to a storage system 210, which is described below in more detail with reference to FIG. 2.

The client device 132 may be a computing device that includes a memory and a processor, for example a laptop computer, a desktop computer, a tablet computer, a mobile telephone, a smartphone, a personal digital assistant (PDA), a mobile email device, a webcam, a user wearable computing device, or any other electronic device capable of accessing a network 120. The client device 132 provides general graphics and multimedia processing for any type of application. The client device 132 includes a display for viewing information provided by the matching server 102. While FIG. 1 illustrates client devices 132a, 132b, and 132n, the disclosure applies to a system architecture having one or more client devices 132.

The ride match engine 104 may include software and/or logic to provide the functionality for performing ridesharing. In some embodiments, the ride match engine 104 can be implemented using programmable or specialized hardware, such as a field-programmable gate array (FPGA) or an application-specific integrated circuit (ASIC). In some embodiments, the ride match engine 104 can be implemented using a combination of hardware and software. In other embodiments, the ride match engine 104 may be stored and executed on a combination of the client devices 132 and the matching server 102, or by any one of the client devices 132 or matching server 102.

In some embodiments, the ride match engine 104 acts as a thin-client application with some functionality executed on the client device 132 and additional functionality executed on the matching server 102 by ride match engine 104. For example, the ride match engine 104 may be executed or partially executed on the client device 132 and could include software and/or logic for inputting information, capturing location data, and transmitting the information and/or location data to the matching server 102. The client device 132 may further display information in a graphical user interface on the client device 132. A thin-client application executed on the client device 132 may include additional functionality described herein with reference to the ride match engine 104 performing ridesharing.

In some embodiments, the ride match engine 104 receives user profile information. The ride match engine 104 analyzes and/or stores user profile information. The ride match engine 104 receives trip details and passenger requests and is able to compare the trip details and passenger requests to the user profile information to determine ride matches. The ride match engine 104 may generate a user interface or provide commands to a client device 132 to generate a user interface for presentation of the ride matches to a user 130. The operation of the ride match engine 104 and the functions listed above are described below in more detail.

In some embodiments, the system 100 includes a third party application 106 coupled to the network 120. The third party application 106 may be, or may be implemented by, a computing device including a processor, a memory, applications, a database, and network communication capabilities. In the example of FIG. 1, the components of the third party application 106 are configured to receive information from the matching server 102 and/or provide access to applications. For example, the third party application 106 may be a calendar application related to a user 130 and the matching server 102 may access the calendar application and schedule trips in the calendar application. In a further example, the third party application 106 may be a map application that receives information related to a route from the matching server 102 and may map the route into the map application for presentation to a user 130. In a further example, the third party application 106 may be a location application capable of providing location data to the matching server 102. In a further example, the third party application 106 may be a payment application configured to receive payment information from a passenger and driver and charge the passenger or driver once a route and/or trip is completed.

In some embodiments, the system 100 includes a group data server 108 coupled to the network 120. In some embodiments, the group data server 108 may be either a hardware server, a software server, or a combination of software and hardware. The group data server 108 may be, or may be implemented by, a computing device including a processor, a memory, applications, a database, and network communication capabilities. In the example of FIG. 1, the components of the group data server 108 are configured to provide group information to the matching server 102. The group information may include user profile information related to users 130 included in a group related to the group data server 108. A group may be an organization or association of users, for example a university or company. The group may be organized by an administrator of the group. The group information may also include parameters related to the group, for example, a label for filtering ride matches to other users 130 included in the group.

FIG. 2 shows a block diagram illustrating one embodiment of a computing device 200 including a ride match engine 104. The computing device 200 may also include a processor 204, a memory 206, a communication unit 202, and a storage system 210 according to some examples. The components of the computing device 200 may be configured to store information and provide the information for reporting and data inquiry. The components of the computing device 200 are communicatively coupled by a bus or software communication mechanism 224. The bus or software communication mechanism 224 may represent one or more buses or software communication mechanisms including an industry standard architecture (ISA), a peripheral component interconnect (PCI) bus, a universal serial bus (USB), or some other bus known in the art to provide similar functionality. In some embodiments, the computing device 200 may be the client device 132, the matching server 102, or a combination of the client device 132 and the matching server 102. In such embodiments where the computing device 200 is the client device 132 or the matching server 102, it should be understood that the client device 132 and the matching server 102 may include other components not shown in FIG. 2.

The processor 204 may execute software instructions by performing various input/output, logical, and/or mathematical operations. The processor 204 may have various computing architectures to process data signals including, for example, a complex instruction set computer (CISC) architecture, a reduced instruction set computer (RISC) architecture, and/or an architecture implementing a combination of instruction sets. The processor 204 may be physical and/or virtual, and may include a single processing unit or a plurality of processing units and/or cores. In some embodiments, the processor 204 may be capable of generating and providing electronic display signals to a display device, supporting the display of images, capturing and transmitting images, performing complex tasks including various types of matching algorithms, analysis, and sampling, etc. In some embodiments, the processor 204 may be coupled to the memory 206 via the bus or software communication mechanism 224 to access data and instructions therefrom and store data therein. The bus or software communication mechanism 224 may couple the processor 204 to the other components of the computing device 200 including, for example, the memory 206, the communication unit 202, the ride match engine 104, and the storage system 210. It will be apparent to one skilled in the art that other processors, operating systems, sensors, displays and physical configurations are possible.

The memory 206 may store and provide access to data for the other components of the computing device 200. The memory 206 may be included in a single computing device or may be distributed among a plurality of computing devices as discussed elsewhere herein. In some embodiments, the memory 206 may store instructions and/or data that may be executed by the processor 204. The instructions and/or data may include code for performing the techniques described herein. For example, in one embodiment, the memory 206 may store the ride match engine 104. The memory 206 is also capable of storing other instructions and data, including, for example, an operating system, hardware drivers, other software applications, databases, etc. The memory 206 may be coupled to the bus or software communication mechanism 224 for communication with the processor 204 and the other components of the computing device 200.

The memory 206 may include one or more non-transitory computer-usable (e.g., readable, writeable) devices, a static random access memory (SRAM) device, an embedded memory device, a discrete memory device (e.g., a PROM, FPROM, ROM), a hard disk drive, an optical disk drive (CD, DVD, Blu-Ray™, etc.), which can be any tangible apparatus or device that can contain, store, communicate, or transport instructions, data, computer programs, software, code, routines, etc., for processing by or in connection with the processor 204. In some embodiments, the memory 206 may include one or more of volatile memory and non-volatile memory. It should be understood that the memory 206 may be a single device or may include multiple types of devices and configurations.

The communication unit 202 is hardware for receiving and transmitting data by linking the processor 204 to the network 120 and other processing systems. The communication unit 202 receives data, such as requests, from the client device 132 and transmits the data to the controller 201, for example a request to schedule a trip. The communication unit 202 also transmits information, including ride matches, to the client device 132 for display, for example, a ride match may be transmitted in response to determining a driver route and passenger request meet certain parameters. The communication unit 202 is coupled to the bus or software communication mechanism 224. In one embodiment, the communication unit 202 may include a port for direct physical connection to the client device 132 or to another communication channel. For example, the communication unit 202 may include an RJ45 port or similar port for wired communication with the client device 132. In another embodiment, the communication unit 202 may include a wireless transceiver (not shown) for exchanging data with the client device 132 or any other communication channel using one or more wireless communication methods, such as IEEE 802.11, IEEE 802.16, Bluetooth® or another suitable wireless communication method.

In yet another embodiment, the communication unit 202 may include a cellular communications transceiver for sending and receiving data over a cellular communications network such as via short messaging service (SMS), multimedia messaging service (MMS), hypertext transfer protocol (HTTP), direct data connection, push notification, WAP, e-mail or another suitable type of electronic communication. In still another embodiment, the communication unit 202 may include a wired port and a wireless transceiver. The communication unit 202 also provides other conventional connections to the network 120 for distribution of files and/or media objects using standard network protocols such as TCP/IP, HTTP, HTTPS and SMTP as will be understood to those skilled in the art.

The storage system 210 is a non-transitory memory that stores data for providing the functionality described herein. The storage system 210 may be a dynamic random access memory (DRAM) device, a static random access memory (SRAM) device, flash memory or some other memory device. In some embodiments, the storage system 210 also may include a non-volatile memory or similar permanent storage device and media including a hard disk drive, a solid state drive, a floppy disk drive, or some other mass storage device for storing information on a more permanent basis. In some embodiments, the storage system 210 may optionally include a passenger request database 214a, a driver route and trip details database 214b, and/or a driver profile database 214c. The databases 214 may be sections of memory included in storage system 210. In the illustrated embodiment, the storage system 210 is communicatively coupled to the bus or software communication mechanism 224. The storage system 210 stores data for performing ridesharing and other functionality as described herein. The data stored in the storage system 210 and/or databases 214 is described below in more detail.

In some embodiments, the ride match engine 104 may include a controller 201, a user profile module 212, a trip module 216, a matching module 218, a mapping module 220, and a user interface module 222. The components of the ride match engine 104 are communicatively coupled via the bus or software communication mechanism 224. The components of the ride match engine 104 can be implemented using programmable or specialized hardware including a field-programmable gate array (FPGA) or an application-specific integrated circuit (ASIC). In some embodiments, the components of the ride match engine 104 can be implemented using a combination of hardware and software executable by processor 204. In other embodiments, the components of the ride match engine 104 comprise instructions executable by the processor 204. In some embodiments, components of the ride match engine 104 are stored in the memory 206 and are accessible and executable by the processor 204. Additionally, the components of the ride match engine 104 may be adapted for cooperation and communication with the processor 204, the memory 206, and other components of the ride match engine 104 via the bus or software communication mechanism 224

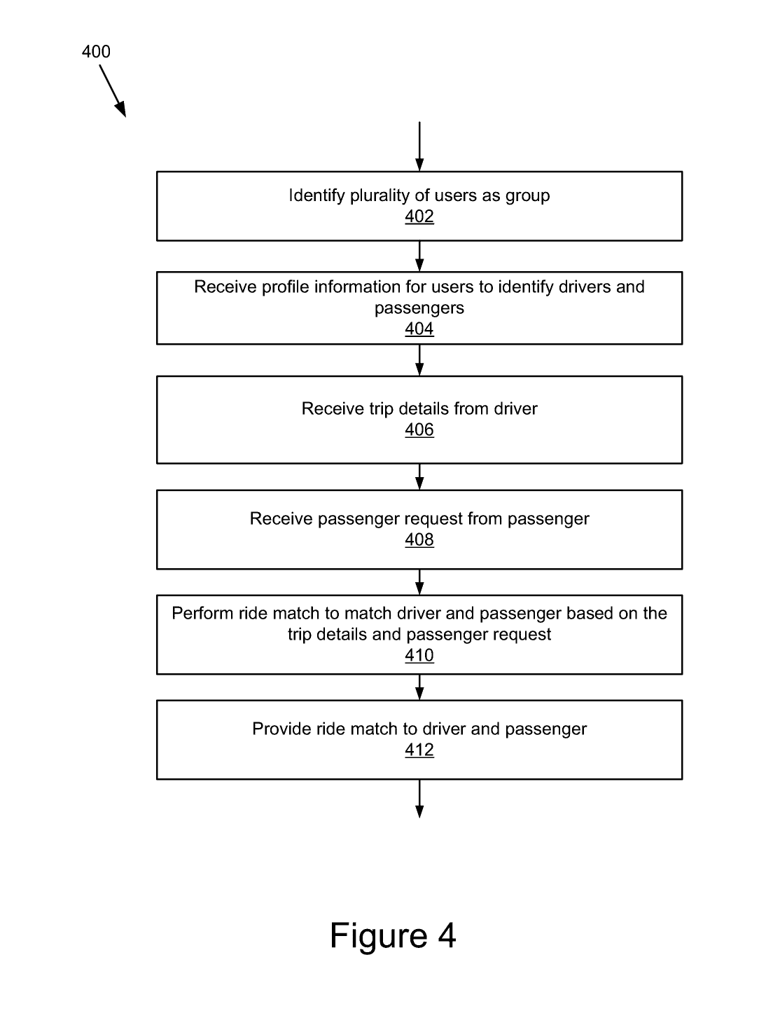

The controller 201 may include software and/or logic to control the operation of the other components of the ride match engine 104. The controller 201 controls the other components of the ride match engine 104 to perform the methods described below with reference to FIGS. 4-9. The controller 201 may also include software and/or logic to provide the functionality for handling communications between the ride match engine 104 and other components of the computing device 200 as well as between the components of the ride match engine 104.

In some embodiments, the controller 201 sends and receives data, via the communication unit 202, to and from one or more of the client device 132 and the matching server 102. For example, the controller 201 receives, via the communication unit 202, a passenger request from a client device 132 operated by a user 130 and sends the passenger request to the trip module 216. In another example, the controller 201 receives location data from the communication unit 202 connected to the third party application 106 and/or a location sensor included on the client device 132 and sends the location data to the mapping module 220, for the mapping module 220 to map the location.

In some embodiments, the controller 201 receives data from other components of the ride match engine 104 and stores the data in the storage system 210. For example, the controller 201 receives data including user profile information from the user profile module 212 and stores the user profile information in the storage system 210. In other embodiments, the controller 201 retrieves data from the storage system 210.

The user profile module 212 may include software and/or logic to provide the functionality for receiving, storing, and retrieving information related to users 130. In some embodiments, the user profile module 212 can perform the methods, implement the user interfaces, and other functions described below with reference to FIGS. 4-26 to send and receive user profile information related to users 130.

The trip module 216 may include software and/or logic to provide the functionality for receiving, storing, and retrieving information related to trip details provided by one or more users 130. In some embodiments, the trip module 216 can perform the methods, implement the user interfaces, and other functions described below with reference to FIGS. 4-26 to send and receive trip detail information related to users 130.

The matching module 218 may include software and/or logic to provide the functionality for receiving user profile information, trip details, and a passenger request, and determining a ride match. In some embodiments, the matching module 218 can perform the methods, implement the user interfaces, and other functions described below with reference to FIGS. 4-26 to determine ride matches and provide them to the user interface module 222 for presentation to a user 130.

The mapping module 220 may include software and/or logic to receive location data and using the location data map the location of a driver and/or passenger. In some embodiments, the mapping module 220 can be configured to receive location data from the third party application 106 and/or the client device 132. In some embodiments, the mapping module 220 can perform the methods, implement the user interfaces, and other functions described below with reference to FIGS. 4-26 to map location data of driver and/or passenger.

The user interface module 222 may include software and/or logic to provide the functionality for receiving information from other components of the computing device 200 and presenting the information in a generated user interface to a user 130 via a display device. In some embodiments, the user interface module 222 may optionally be included in the matching server 102. In further embodiments, the user interface module 222 may optionally be incorporated into a client device 132. In some embodiments, the user interface module 222 can perform the methods, implement the user interfaces, and other functions described below with reference to FIGS. 4-26 to present information in a user interface.

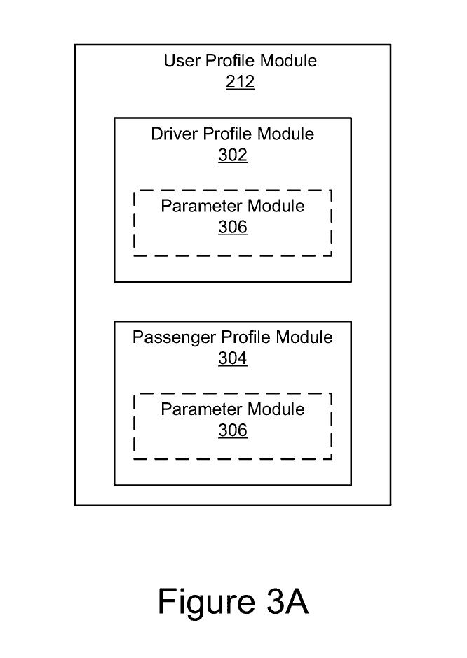

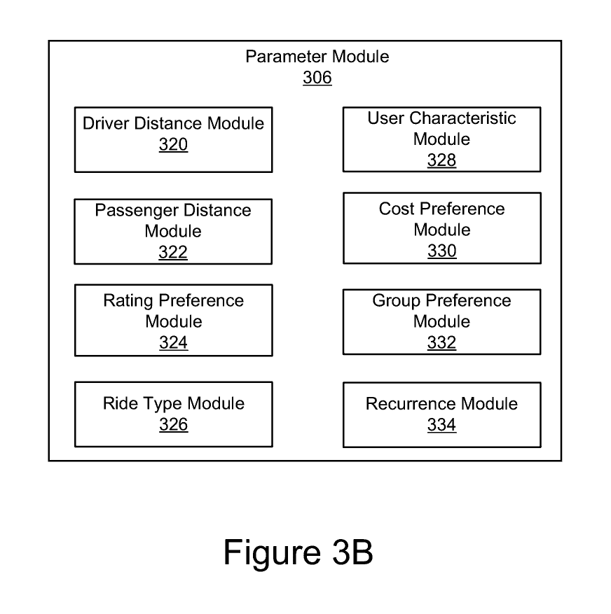

FIG. 3A shows a block diagram illustrating one embodiment of the user profile module 212 of the example computing device 200. In the example embodiment of FIG. 3A, the user profile module 212 may include a driver profile module 302 and a passenger profile module 304.

The driver profile module 302 may include software and/or logic to provide the functionality for receiving driver profile information from a client device 132, storing the driver profile information in the storage system 210, and retrieving relevant driver profile information upon request. In some embodiments, the driver profile module 302 may optionally include a parameter module 306 described elsewhere herein. In some embodiments, the driver profile module 302 is configured to store and retrieve the driver profile information from the driver profile database 214c.

The passenger profile module 304 may include software and/or logic to provide the functionality for receiving passenger profile information from a client device 132, storing the passenger profile information in the storage system 210, and retrieving relevant passenger profile information upon request. In some embodiments, the passenger profile module 304 may optionally include a parameter module 306 described elsewhere herein. In some embodiments, the passenger profile module 304 is configured to store and retrieve the passenger profile information from the passenger request database 214a.

FIG. 3B shows a block diagram illustrating one embodiment of the parameter module 306. In the example embodiment of FIG. 3B, the parameter module 306 may include a driver distance module 320, a passenger distance module 322, a rating preference module 324, a ride type module 326, a user characteristic module 328, a cost preference module 330, a group preference module 332, and a recurrence module 334.

The driver distance module 320 may include software and/or logic to provide the distance defined by a driver or administrator related to the distance a driver is willing to deviate from the overall distance of the driver route to pick up a passenger. The driver distance module 320 may be configured to provide the driver distance parameter to the matching module 218 for use in the matching algorithm to determine a ride match. The driver distance module 320 may be configured to receive a driver distance parameter from the user profile module 212 and/or a client device 132.

The passenger distance module 322 may include software and/or logic to provide the distance defined by a passenger or administrator related a distance beyond a pickup location a passenger may travel to be picked up. The passenger distance module 322 may be configured to provide the passenger distance parameter to the matching module 218 for use in the matching algorithm to determine a ride match. The passenger distance module 322 may be configured to receive a passenger distance parameter from the user profile module 212 and/or a client device 132.

The rating preference module 324 may include software and/or logic to provide the functionality for a rating parameter selected by a user 130 or administrator. The rating preference module 324 may be configured to provide the rating parameter to the matching module 218 for use in the matching algorithm to determine a ride match. The rating preference module 324 may be configured to receive a rating parameter from the user profile module 212 and/or a client device 132.

The ride type module 326 may include software and/or logic to provide the functionality for a ride type parameter selected by a user 130 or administrator. The ride type module 326 may be configured to provide the ride type parameter to the matching module 218 for use in the matching algorithm to determine a ride match. The ride type module 326 may be configured to receive a ride type parameter from the user profile module 212 and/or a client device 132.

The user characteristic module 328 may include software and/or logic to provide the functionality for a user characteristic selected by a user 130 or administrator. The user characteristic module 328 may be configured to provide the user characteristic to the matching module 218 for use in the matching algorithm to determine a ride match. The user characteristic module 328 may be configured to receive the user characteristic from the user profile module 212 and/or a client device 132.

The cost preference module 330 may include software and/or logic to provide the functionality for a cost preference parameter selected by a user 130 or administrator. The cost preference module 330 may be configured to provide the cost preference parameter to the matching module 218 for use in the matching algorithm to determine a ride match. The rating preference module 324 may be configured to receive a cost preference parameter from the user profile module 212 and/or a client device 132.

The group preference module 332 may include software and/or logic to provide the functionality for a group parameter selected by a user 130 or administrator. The group preference module 332 may be configured to provide the group parameter to the matching module 218 for use in the matching algorithm to determine a ride match. The group preference module 332 may be configured to receive a group parameter from the user profile module 212 and/or a client device 132.

The recurrence module 334 may include software and/or logic to provide the functionality for a recurrence parameter selected by a user 130 or administrator. The recurrence module 334 may be configured to provide the recurrence parameter to the matching module 218 for use in the matching algorithm to determine a ride match. The recurrence module 334 may be configured to receive a recurrence parameter from the user profile module 212 and/or a client device 132.

FIG. 4 shows a flow diagram 400 illustrating one embodiment of a method for performing ridesharing. At 402, the user profile module 212 identifies a plurality of users 130 as a group. In some embodiments, the users 130 may be identified by user profiles created by the user profile module 212. In some embodiments, the users 130 may be new and prompted to create a user profile via a graphical user interface generated by the user interface module 222. In further embodiments, the users 130 may have previously created user profiles and the user profile module 212 retrieves the previously created user profiles. User profiles include information related to each user. For example, a user profile may include profile information such as a name, a home address, a work address, a gender, a rating, a car type, cost per mile, user characteristics, etc. In some embodiments, the user profiles may be created by an administrator instead of a user, while in further embodiments, the user profiles may be created by information provided by the user 130 and the administrator.

In some embodiments, users 130 are identified as a group. A group may be created from users 130 who belong to, or are associated with, a common organization. For example, a group may include students and faculty at a school or university, employees of a company, users that have opted into a specific program (e.g., users that have a special customer designation at a theme park, etc.), etc. In some embodiments, a user 130 may indicate a group he or she belongs to when the user 130 creates a user profile. In further embodiments, an administrator of the group designates various users 130 as part of a group. In some embodiments, the users 130 are identified as a group based on a label or tag included in each user's profile. In further embodiments, the users 130 are identified as a group based on a special login associated with the group.

At 404, the user profile module 212 receives profile information for the users 130 to identify drivers and passengers. In some embodiments, the profile information related to each user includes designations of driver or passenger. For example, when a user 130 registers and creates a user profile, the user can designate himself as a driver and/or a passenger. In some embodiments, the user profile module 212 receives the profile information by retrieving the profile information from the storage system 210. In further embodiments, the user profile module 212 receives the profile information directly from a user 130 via a client device 132 and creates a new user profile for each user. In further embodiments, the user profile module 212 receives group data from the group data server 108 and uses the group data to retrieve or create user profiles.

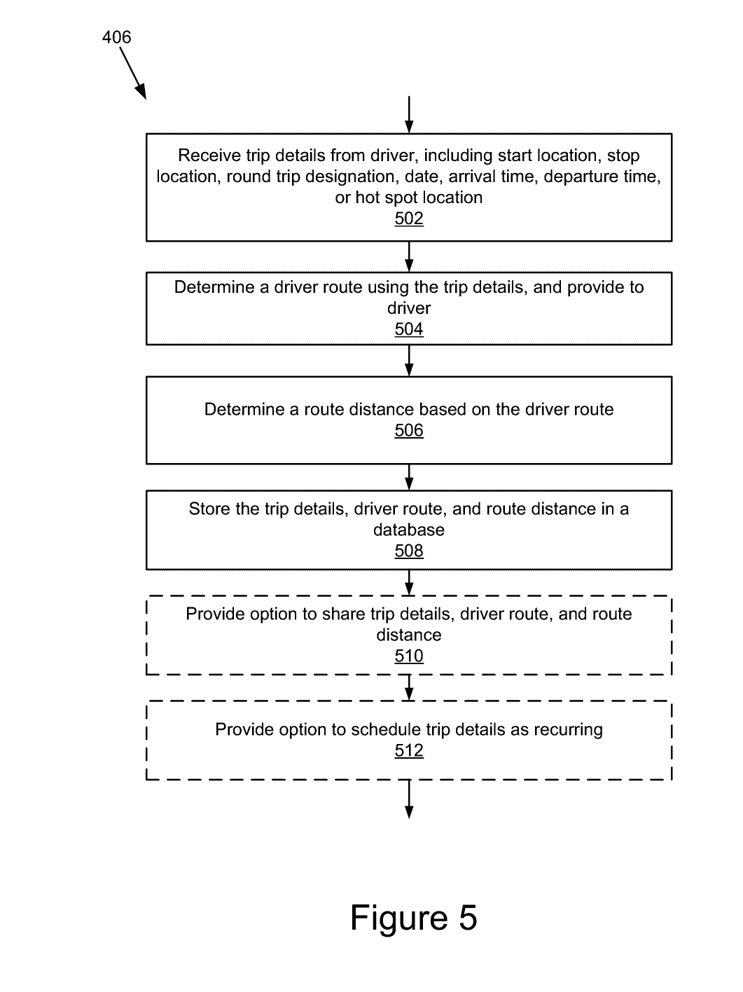

At 406, the trip module 216 receives trip details from a driver. In some embodiments, drivers are users 130 of the plurality of users that have designated in their profile information that they are drivers. The profile information related to a driver may include a picture of a car, car details, a rate per mile, a default rate, a total miles added, a miles radius, available seats referred to as vehicle capacity, etc. The trip details received from the driver may include a driver start location, a driver stop location, a one way or round trip designation, a date of the trip, an arrival time, a departure time, or a hot spot location, as will be discussed in more detail with reference to FIG. 5. In some embodiments, the trip module 216 stores the trip details in the driver route and trip details database 214b of the storage system 210 for future analysis.

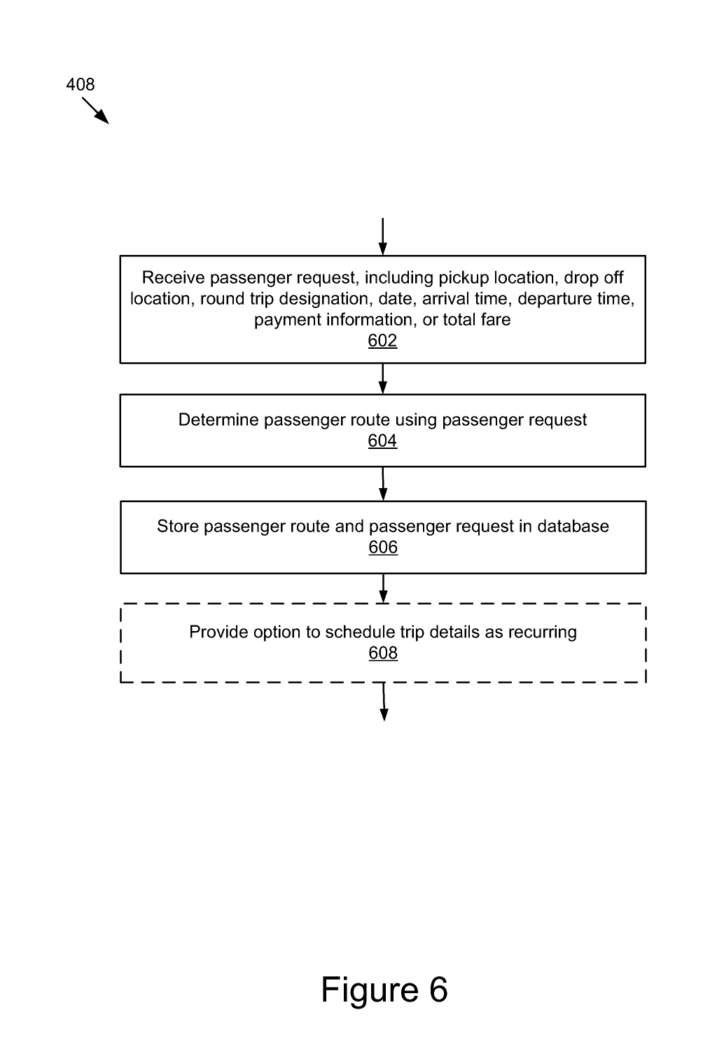

At 408, the trip module 216 receives a passenger request from a passenger. In some embodiments, passengers are users 130 of the plurality of users that have designated in their profile information that they are passengers. The passenger request received from the passenger may include a pickup location, a drop off location, a one way or round trip designation, a date, an arrival time, a departure time, payment information, or a total fare, as will be discussed in more detail with reference to FIG. 6. In some embodiments, the trip module 216 stores the passenger request in the passenger request database 214a of the storage system 210 for future analysis.

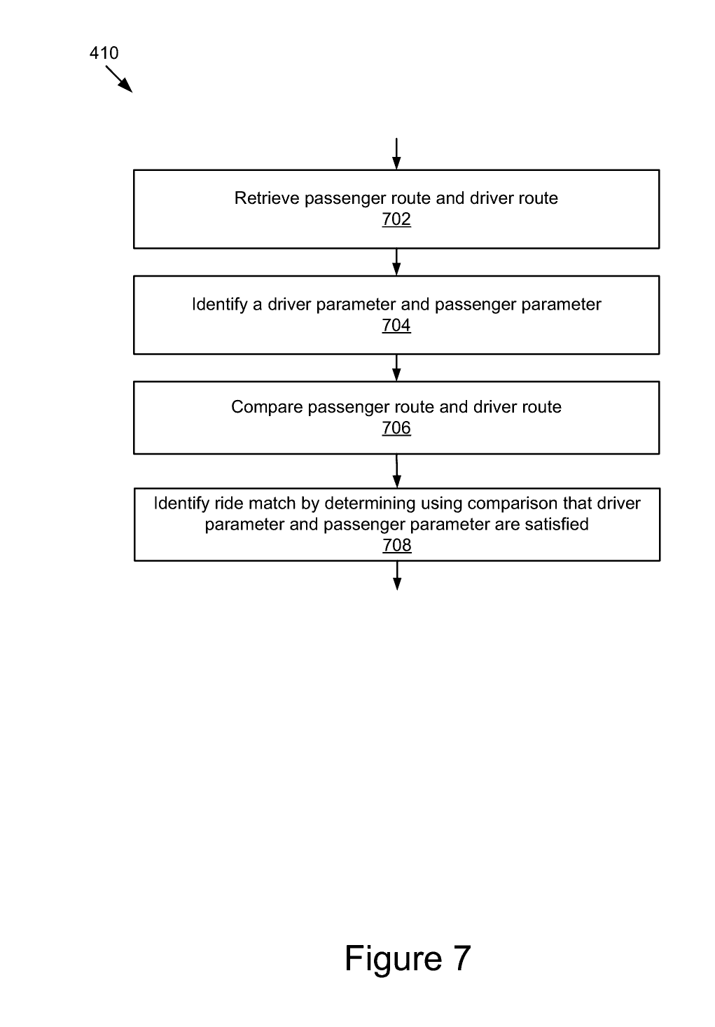

At 410, the matching module 218 performs a ride match to match the driver and the passenger based on the trip details and passenger request. In some embodiments, the ride match is a list of drivers that have driver routes based on the start and stop locations that are near the pickup and drop off locations of the passenger. The matching module 218 may factor in various parameters when performing the ride match to take into account preferences of the driver and/or passenger. The various parameters are discussed in more detail with reference to FIG. 7. In some embodiments, the matching module 218 retrieves the passenger request and trip details from the databases 214 to perform the ride match analysis.

At 412, the user interface module 222 receives the ride match from the matching module 218 and provides the ride match to the driver and the passenger. In some embodiments, the user interface module 222 may generate a user interface including a listing of various drivers that had driver routes along a passenger's path and present the list to the passenger. In further embodiments, once the passenger has selected a driver from the list of various drivers, the user interface module 222 may present the ride match information to the driver in a separate user interface as discussed elsewhere herein. In some embodiments, the driver and/or the passenger may have the option to review the presented ride match and accept or reject the ride match. For example, a passenger may receive a list of potential ride matches that meet the passenger request and parameters and the passenger can select each potential driver and review the potential driver profiles. In another example, a driver may receive the presented ride match and the driver can review the profile of the passenger and the passenger pickup and drop off locations. The passenger and/or the driver may be able to reject or modify the route after reviewing the ride match.

FIG. 5 shows a flow diagram 406 illustrating a method of receiving trip details from a driver. At 502, the trip module 216 receives trip details from a driver. In some embodiments the trip details include a start location, a stop location, a one way or round trip designation, a date, an arrival time, a departure time, or hot spot location(s).

The start location may be an address or other type of location entered by the driver indicating where the driver will start the trip. In some embodiments, once the driver starts the trip from the start location, location data may be gathered and provided to passengers, and tracking of the miles for determining of the trip cost may begin. In one example, the start location may be a home address if the driver is heading into work in the morning. In another example, the start location may be a work address if the driver is headed home from work in the evening. In further embodiments, the start location may be any location the driver inputs using the client device 132.

The stop location may be an address or other type of location entered by the driver indicating where the trip will stop. In some embodiments, once the driver stops the trip, the location data will stop being gathered and provided to the passengers. In further embodiments, once the driver stops the trip, the tracking of miles will stop, the trip cost will be calculated, and payment processed. In one example, the stop location may be a work address if the driver is headed into work in the morning. In another example, the stop location may be a home address if the driver is headed home from work in the evening. In further embodiments, the stop location may be any location the driver inputs using the client device 132.

The round trip designation may be an indication that the driver will be returning to the start location from the stop location later. In one embodiment, the driver may select the trip to be a one way or round trip using selectable buttons in a user interface presented by the user interface module 222.

The date may be a specific calendar date when the trip will occur. The driver may select the date that the trip will occur. In some embodiments, the driver may select multiple days to schedule a trip with the same information. In further embodiments, the driver may select the trip to be recurring, such as every Monday, every weekday, etc.

The arrival time may be a specific time that the driver will arrive at the stop location. In some embodiments, the arrival time may be an estimated time entered by the driver. In further embodiments, the arrival time may be calculated based on the start and stop locations as well as the departure time (and traffic conditions and or other travel conditions provided by a third party app 106). The departure time may be a specific time that the driver will leave the start location. For example, a driver may input a start time of 6:30 am to leave the start location (e.g., house) to head into work for the morning and input an estimated arrival time of 7:15 am to arrive at the stop location (e.g., work).

The hot spot location may be a location entered by the driver where passengers should gather to be picked up. The hot spot location may be an address or another location identifier that other users 130 may congregate for pickup.

At 504, the trip module 504 may determine a driver route using the trip details and provide the driver route to the driver. In some embodiments, the driver route may be determined by the mapping module 220 by mapping the start location and stop location and identifying various routes along the roadways that the driver may take to reach the stop location. In one embodiment, the mapping module 220 may optimize the driver route to be the shortest and/or quickest route from the start location to the stop location. In further embodiments, the mapping module 220 may receive information from the third party application 106 related to the various driver routes and the mapping module 220 may incorporate that information into the optimization of the driver route. For example, the third party application 106 may provide real-time traffic updates and the mapping module 220 may adjust the driver route from the shortest route to another route that avoids an area of congested traffic. In some embodiments, the user interface module 222 may receive the driver route and present the driver route to the driver.

At 506, the trip module 516 may determine a route distance based on the driver route. In some embodiments, the trip module 516 may determine the route distance by determining the distance (e.g., miles) from the start location to the stop location along the driver route. In further embodiments, the trip module 516 may also incorporate a time of the route into the route distance determination.

At 508, the trip module 516 may store the trip details, driver route, and route distance, available seats in the driver route (e.g., vehicle capacity), and trip details database 214b. In some embodiments, the trip module 516 may access the stored trip details, driver route, and route distance for analysis or comparison with information related to other drivers.

At 510, the user interface module 522 may optionally provide the option for the driver to share the trip details, driver route, and route distance. In some embodiments, the user interface module 522 may be coupled to a third party application 106 via the network 120 that allows the driver to share the information to social media or various other applications. In one embodiment, the trip module 216 provides the functionality to detect when information is shared and provide an incentive for sharing, such as a coupon, etc.

At 512, the user interface module 522 may optionally present to the driver an option to schedule the trip details as a recurring trip. In one embodiment, if the driver selects the trip details as recurring then the trip module 216 will store the trip details for the various recurring dates in the driver route and trip details database 214b. In a further embodiment, the trip module 216 may also access a calendar associated with the driver via the third party application 106 and schedule the trip details in the calendar.

FIG. 6 shows a flow diagram 408 for receiving a passenger request from a passenger. At 602, the trip module 216 may receive a passenger request. In some embodiments, the passenger request may include a pickup location, a drop off location, a one way or round trip designation, a date, an arrival time, a departure time, payment information, or total fare.

The pickup location may be an address or other type of location entered by the passenger indicating where the passenger will be picked up. In one example, the pickup location may be a home address if the passenger is heading into work in the morning. In another example, the pickup location may be a work address if the passenger is headed home from work in the evening. In a further embodiment, the pickup location may be a park and ride location that the passenger travels to and waits for pick up. In a further embodiment, the pickup location may be a hot spot location designated by a driver and selected by the passenger as described elsewhere herein. In further embodiments, the pickup location may be any location the passenger inputs using the client device 132.

The drop off location may be an address or other type of location entered by the passenger indicating where the passenger will be dropped off. In one example, the drop off location may be a work address if the passenger is heading into work in the morning. In another example, the drop off location may be a home address if the passenger is headed home from work in the evening. In further embodiments, the drop off location may be any location the passenger inputs using the client device 132.

The payment information may include a credit card or other payment type input by the passenger. The trip module 216 may be configured to receive the payment information and provide the payment information to a trusted third party application 106 for processing of the payment upon completion of the trip. In some embodiments, the payment information may be included in the user profile of the passenger rather than the passenger request. In further embodiments, the payment information may be removed or managed by an administrator rather than directly by the user 130.

The total fare may be a total amount for a trip from the pickup location to the drop off location. In one embodiment, the total amount may be determined by the mapping module 220 calculating the miles between the pickup location and drop off location. In some embodiments, the total fare may be an estimated amount that may change based on one or more parameters of the driver.

The round trip designation, date, arrival time, and departure time are similar to those described above with respect to FIG. 5, however rather than being related to the driver they are the requests from the passenger. The passenger may input a one way or round trip designation, a date for the trip, an arrival time at the drop off location, or a departure time at the pickup location.

At 604, the trip module 216 may determine a passenger route using the passenger request. In some embodiments, the passenger route may be determined by the mapping module 220 determining the distance between the pickup location and drop off location. In further embodiments, the mapping module 220 may determine multiple passenger routes based on the shortest distance, fastest route based on traffic, etc.

At 606, the trip module 216 may store the passenger route and passenger request in the passenger request database 214a. In some embodiments, the trip module 516 may access the stored passenger request and passenger route for analysis or comparison with information related to other passengers.

At 608, the user interface module 522 may optionally present to the passenger an option to schedule the trip details as recurring. In one embodiment, if the passenger selects the trip details as recurring then the trip module 216 will store the trip details for the various recurring dates in the passenger request database 214a. In a further embodiment, the trip module 216 may also access a calendar associated with the passenger via the third party application 106 and schedule the trip details in the calendar.

FIG. 7 shows a flow diagram 410 for performing a ride match to match a driver and passenger based on the trip details and passenger request. At 702, the matching module 218 retrieves the passenger route and driver route from the passenger request database 214a and driver route and trip details database 214b respectively. The passenger route may be calculated based on the pickup and drop off locations as described elsewhere herein. The driver route may be calculated based on the start and stop locations as described elsewhere herein. In some embodiments, the matching module 218 may retrieve a specific passenger route and multiple driver routes for comparison with the passenger route.

At 704, the user profile module 212 may identify a driver parameter and a passenger parameter. The parameters may be identified by accessing the driver profile and passenger profile associated with the driver route and passenger route. In some embodiments, the parameter module 306 may determine various parameters associated with the driver and passenger.

In some embodiments, the driver distance module 320 may identify the driver distance parameter. The driver distance parameter may be a numerical value of a threshold distance beyond the driver route that a driver will travel to a pickup or drop off location. In some embodiments, the driver distance parameter may be selected by the driver, a default value, or input by an administrator.

In some embodiments, the passenger distance module 322 may identify the passenger distance parameter. The passenger distance parameter may be a numerical value of a threshold distance beyond the passenger route that the passenger will travel to be picked up or dropped off. In some embodiments, the passenger distance parameter may be selected by the driver, a default value, or input by an administrator.

In some embodiments, the rating preference module 324 may identify a rating parameter. The rating parameter may be threshold rating value that a passenger or a driver requests. The threshold rating value may be a value below which prospective passengers or drivers will not be matched even if the other parameters result in a ride match. In some embodiments, passengers and/or drivers may rate their respective drivers and/or passengers from previous trips and provide reviews for future users. A ride match with a driver or passenger having an average rating or review below the threshold rating value may not be included as a ride match. In further embodiments, the rating parameter may include a minimum number of reviews or ratings value and any passenger or driver below that minimum number of reviews (e.g., a new driver or passenger) will not be considered for a ride match.

In some embodiments, the ride type module 326 may identify a ride type parameter. The ride type parameter may indicate which types of rides a passenger will consider for ride matching. The ride match is capable of being performed using a variety of transportation modes including personal vehicles, public transportation, van pools, ferries, etc. The passenger may be able to filter the ride match to consider certain ride types. In some embodiments, drivers may drive various types of cars, for example, cars, SUVs, trucks, vans, etc. In further embodiments, drivers may be included that driver motorcycles, large vans, van pools, etc. In further embodiments, the ride match may include buses, trains, various public transportation, shuttles, ferries, etc. The ride type parameter allows the passengers to select which types of vehicles they would like to be matched. In some embodiments, the ride type module 326 includes a default setting that matches to popular ride types, all types, or cars only, etc.

In some embodiments, the user characteristic module 328 may identify a user characteristic. The user characteristic may be a characteristic of a passenger or driver that may be used to filter out certain passengers and/or drivers. In some embodiments, the user characteristic may include an age, gender, occupation, car type, etc. A passenger or driver may input various user characteristics to refine the ride match to users with the input characteristics.

In some embodiments, the cost preference module 330 may identify a cost preference parameter. The cost preference parameter may be a characteristic set by a passenger or driver for a total cost of the trip. In some embodiments, the passengers or drivers may set a threshold numerical value related to the cost that they would not exceed for ride match determinations. The cost preference parameter may be a rate per mile, a total rate, or another form of payment filtering.

In some embodiments, the group preference module 332 may identify a group parameter. The group parameter may identify a specific group of users from which the ride match will be determined. For example, a passenger may set a group parameter to only search for a ride match among drivers that attend the same university, work at the same location, etc.

In some embodiments, the recurrence module 334 may identify a recurrence parameter. The recurrence parameter may be used during ride matches to identify ride matches that are reoccurring. The recurrence parameter may be input by the passenger and/or driver and identify specific dates for recurring trips or other variations for filtering.

At 706, the matching module 218 compares the passenger route and driver route. In some embodiments, the matching module 218 compares the distances of how far from the driver route the passenger routes are. In further embodiments, the matching module 218 compares the overlap between the passenger route and driver route. In further embodiments, the matching module 218 may use the mapping module to compare the distances and overlap between the passenger route and driver route to identify portions of various driver routes that are similar to the passenger route.

At 708, the matching module 218 identifies a ride match by determining using the comparison between driver and passenger routes, that the driver parameter and passenger parameter are satisfied. In some embodiments, the parameter module 306 may use the identified passenger parameter and driver parameter and do conditional comparisons to identify ride matches that satisfy the various parameters. For example, a passenger parameter may include only drivers with a positive rating, and the parameter module 306 may filter out all ride matches with drivers that include a negative rating. In another example, a driver may have a driver distance of 5 miles beyond the driver route and a passenger pickup location is 4 miles beyond the driver route so the parameter module 306 will identify the driver distance parameter as being satisfied.

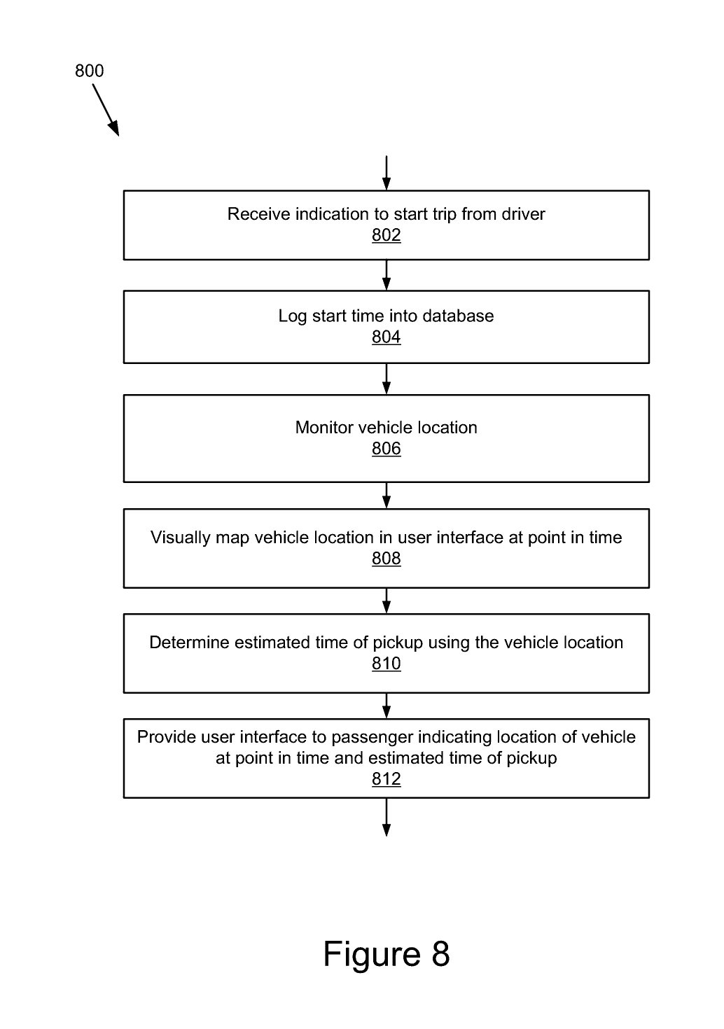

FIG. 8 shows a flow diagram 800 of one embodiment of a method for providing indications of ridesharing locations. At 802, the trip module 216 receives an indication to start a trip from a driver. The trip may be a scheduled trip that includes the driver and a passenger. In some embodiments, the user interface module 222 may provide a graphical user interface for the driver to view and a selectable button for the driver to indicate that the trip is starting. The user interface module 222 may provide a notification to the trip module 216 in response to the driver selecting the button.

At 804, the trip module 216 logs the start time into a database. The trip module 216 may store the start time in the storage system 210 or a specific database 214. The start time may be logged to begin determining trip costs, trip time, and/or trip total distance.

At 806, a third party application 106 or the client device 132 may monitor the vehicle location of the driver and vehicle. The client device 132 or third party application 106 monitors the vehicle location using location sensors, such a GPS sensors or other location detecting techniques. The vehicle location may be provided to the mapping module 220 for determining the location of the vehicle.

At 808, the mapping module 220 may visually map the received vehicle location in the user interface at a point in time. In one embodiment, the mapping module 220 may map the vehicle location onto a virtual map displaying where in the map the location data indicates the vehicles is at different points in time.

At 810, the mapping module 220 may determine an estimated time of pickup of the passenger using the vehicle location. In one embodiment, mapping module 220 may use the vehicle's current location and the distance left to the pickup location to estimate the time remaining for the vehicle to arrive at the pickup location.

At 812, the mapping module 220 may provide the mapping of the vehicle and/or the estimated time to the user interface module 222. The user interface module 222 may provide a user interface to the passenger indicating the location of the vehicle at a point in time and the estimated time of pickup. The user interface module 222 may display the user interface on a display screen of the client device 132. In further embodiments, the user interface module 222 may be configured to provide notifications to the user when the location of the vehicle and/or estimated time reach a minimum threshold. For example, when the vehicle is a block away, the user interface module 222 may provide an alert to the passenger that the driver is arriving soon.

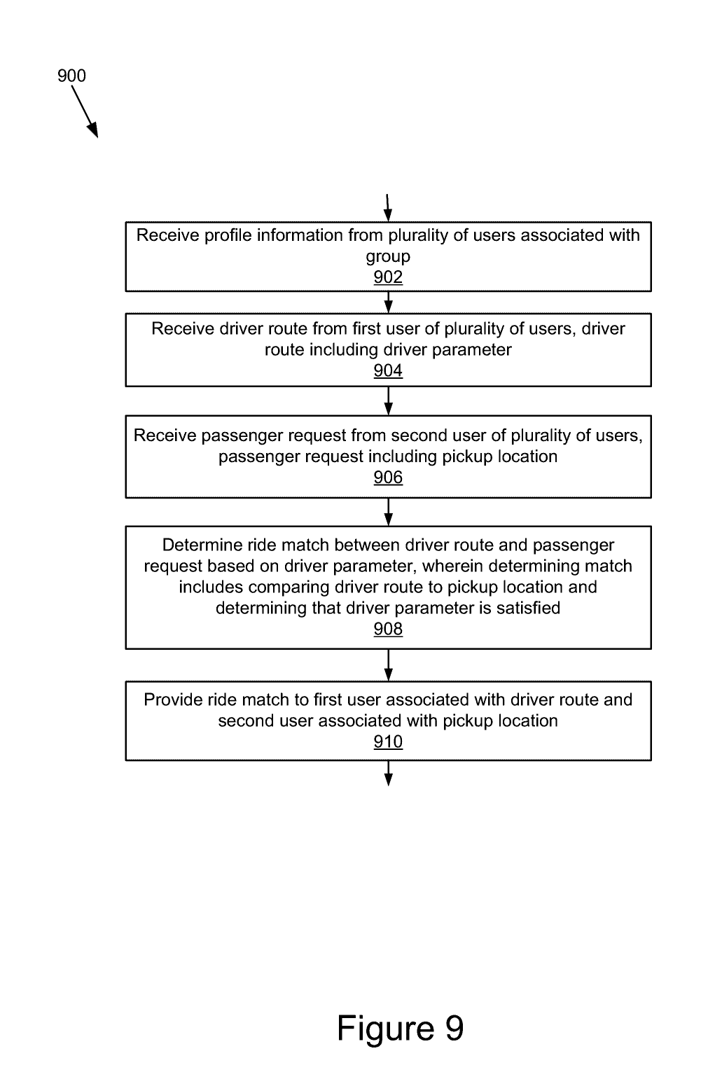

FIG. 9 shows a flow diagram 900 of another embodiment of the method for performing ridesharing. At 902, the user interface module 212 receives profile information from a plurality of users associated with a group. The user interface module 212 may receive various profile information from users including their names, driver or passenger designations, locations, and other characteristics as described elsewhere herein. The user interface module 212 may identify the plurality of users associated with the group and filter ride matches to include only passengers and drivers associated with the group.

At 904, the trip module 216 receives a driver route from a first user of the plurality of users, the driver route including a driver parameter. In one embodiment, the trip module 216 may receive trip details from the first user (e.g., the driver) and the trip details may include the driver route and a driver parameter. The driver route may be calculated based on the start and stop locations as described elsewhere herein. The parameter module 306 may identify the driver parameter included in the driver route. In some embodiments, the driver parameter may be a driver distance parameter identified by the driver distance module 320.

At 906, the trip module 216 receives a passenger request from a second user of the plurality of users, the passenger request including a pickup location. In some embodiments, the passenger request may include the pickup location and drop off location of the second user (e.g., the passenger). In further embodiments, the passenger request may include other details and parameters described elsewhere herein.

At 908, the matching module 218 determines a ride match between the driver route and passenger request based on the driver parameter, wherein determining the match includes comparing the driver route to the pickup location and determining that the driver parameter is satisfied. In some embodiments, the matching module 218 may determine a ride match by comparing the common points of the driver route and passenger request as described elsewhere herein. In some embodiments, the matching module 218 may determine that the driver parameter is satisfied by determining if the total distance of the trip exceeds the distance of the trip combined with the driver distance parameter. For example, the matching module 218 may use an algorithm to determine if the driver route is forty miles and the driver parameter is ten miles, then the driver parameter is satisfied for any passenger request that keeps the total distance of the trip below fifty miles. In some embodiments, the matching module 218 is continuously performing ride matching by comparing received passenger requests and driver routes using the algorithm and the various parameters. The matching module 218 may continuously retrieve previously stored data from the storage system 210 to perform the ride matching. In further embodiments, the matching module 218 may compare the passenger request to subsequently received driver routes to determine if a later entered driver route is a ride match or alternatively a cheaper or shorter ride match with the passenger request.

By performing continuous analysis of the passenger requests and driver routes a passenger may quickly receive ride matches. Further, ride matches can be scheduled at times other than when the passenger initially submits the passenger request. This may be especially advantageous for a recurring passenger request where there may be a small sample pool of driver routes related to a recurring passenger request at a future date. As the date gets closer and more driver routes are entered for those days, the matching module 218 may compare the new driver routes to the passenger request at the future date and automatically identify a potential ride match without any new promptings from the passenger.

At 910, the user interface module 222 provides the ride match to the first user associated with the driver route and the second user associated with the pickup location. In some embodiments, the matching module 218 may provide the ride match to the user interface module 222 and the user interface module 222 may generate a user interface on the client devices 132 of the first user and second user to present the ride match.

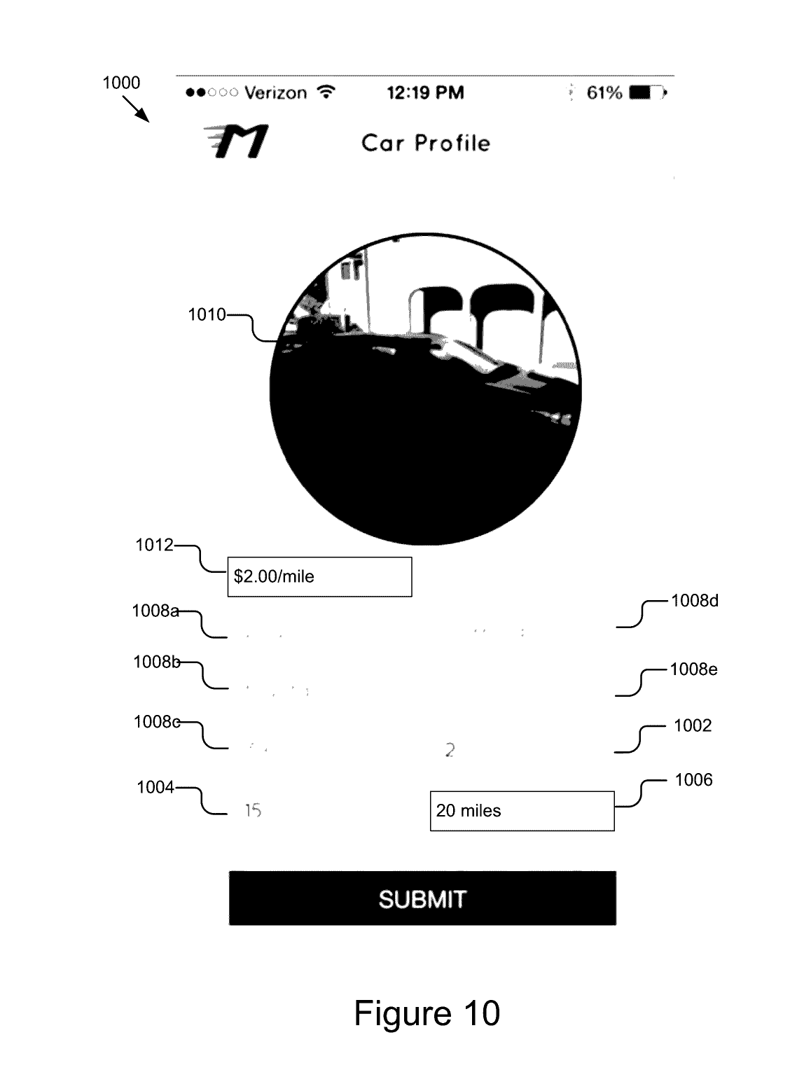

FIG. 10 shows a graphical representation 1000 of one embodiment of a user interface showing a driver profile. The user interface module 222 may generate the user interface to display a driver profile. The user interface module 222 may retrieve and display the driver profile information from the driver profile module 302. In some embodiments, the user interface module 222 may allow the driver to edit fields of the driver profile in the user interface. In some embodiments, the fields in the driver profile may include a number of seats for passengers 1002, referred to as a vehicle capacity, a driver distance parameter 1004, a mile radius parameter 1006, vehicle details 1008, a vehicle picture 1010, and/or a rate per mile 1012.

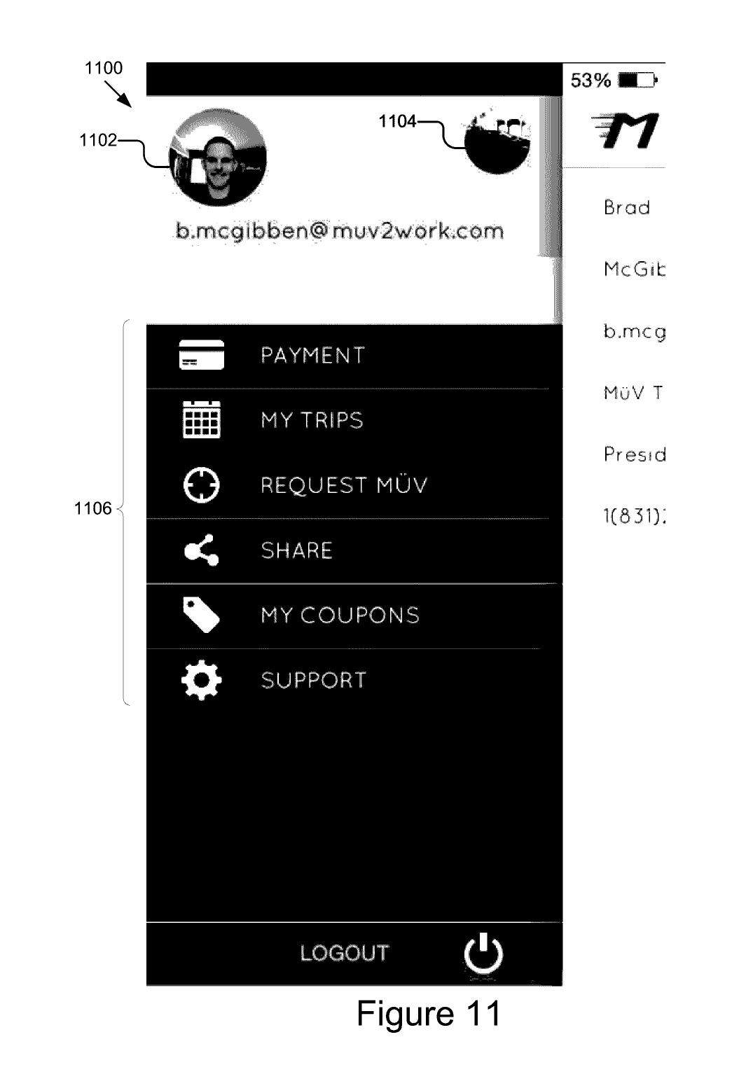

FIG. 11 shows a graphical representation 1100 of another embodiment of a user interface showing a user profile. The user interface module 222 may generate the user interface to display a user profile. The user interface module 222 may retrieve and display user profile information from the user profile module 212. In some embodiments, the user interface module 222 may allow a user 130 to select various options 1106 included within the user profile. The user profile may also include an image of the user 1102 and a selectable button to switch back to a driver profile 1104.

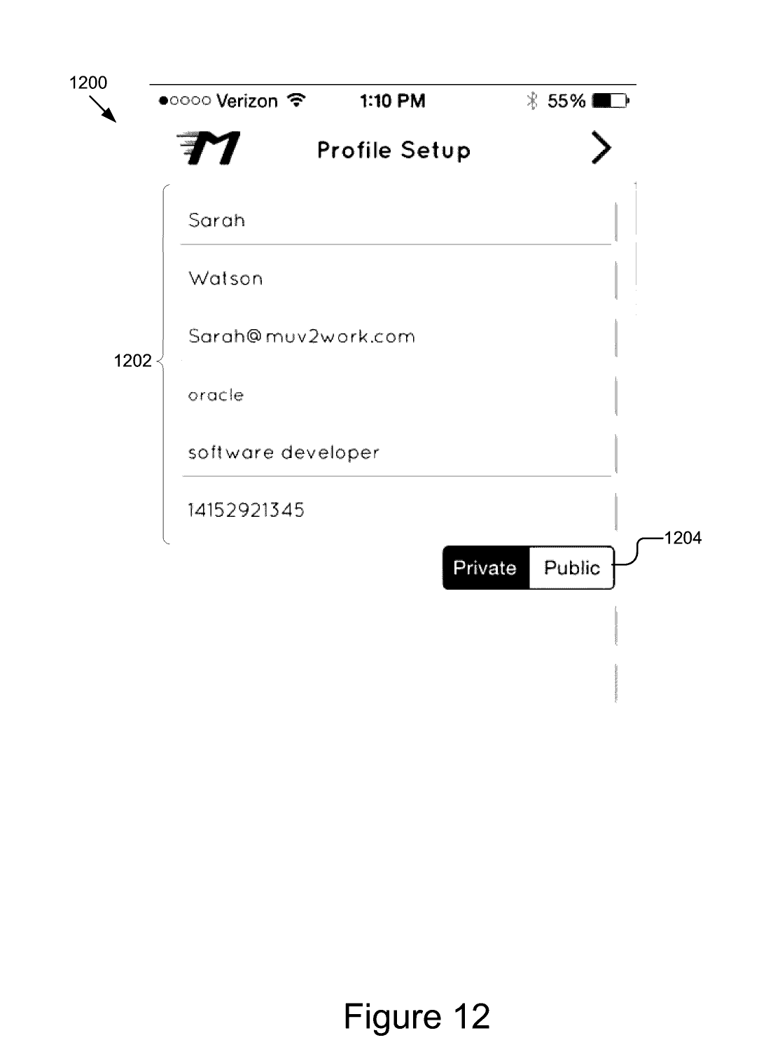

FIG. 12 shows a graphical representation 1200 of another embodiment of the user interface showing the user profile. The user interface module 222 may generate a user interface for a user 130 to set up a user profile. The user profile may include various fields that the user 130 can populate with personal information. In some embodiments, the user interface module 222 provides a privacy option 1204 that the user can select to display the user profile publicly or keep the information private.

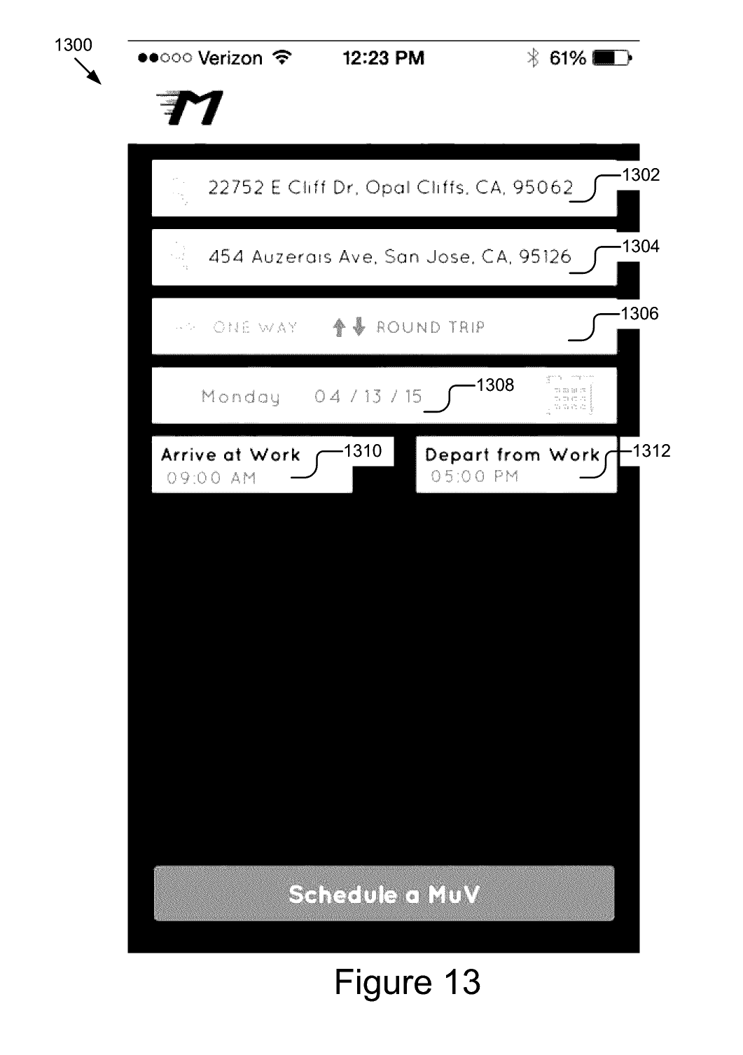

FIG. 13 shows a graphical representation 1300 of another embodiment of the user interface showing trip details. The user interface module 222 may generate a user interface for a user 130 to enter trip details. The trip details may include a start location 1302, a stop location 1304, a one way or round trip designation 1306, a date 1308, an arrival time 1310, and a departure time 1312.

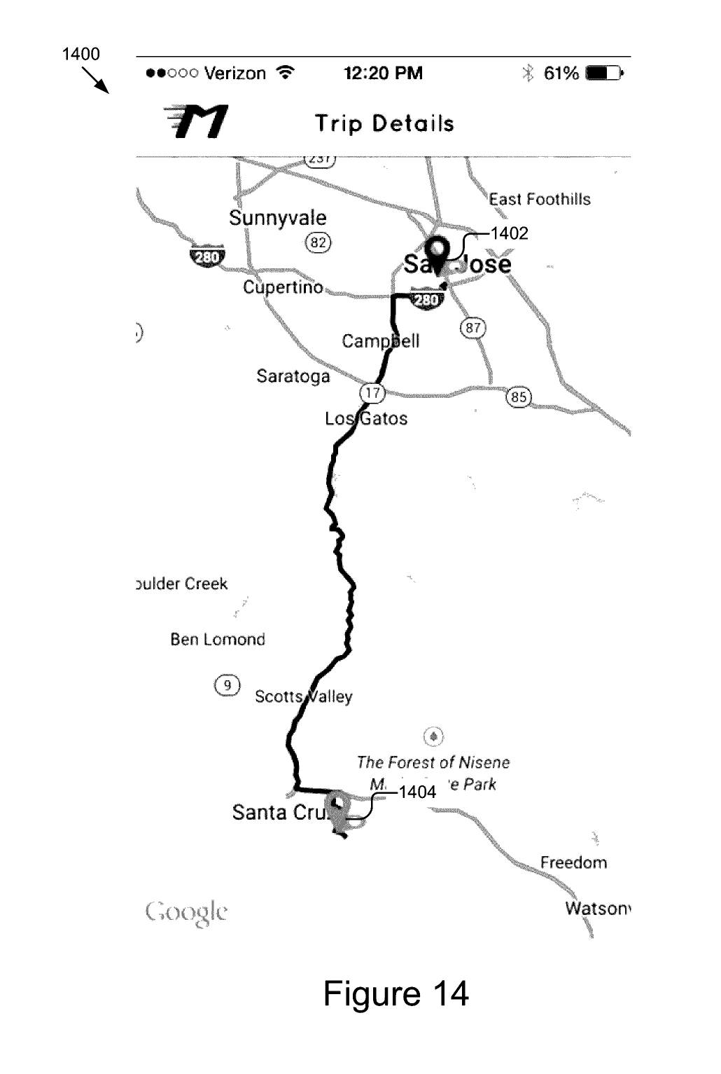

FIG. 14 shows a graphical representation 1400 of another embodiment of the user interface showing a driver route. The user interface module 222 may generate a user interface displaying a mapping of the driver route as described elsewhere herein. The mapping may include a start location 1402 and an end location 1404.

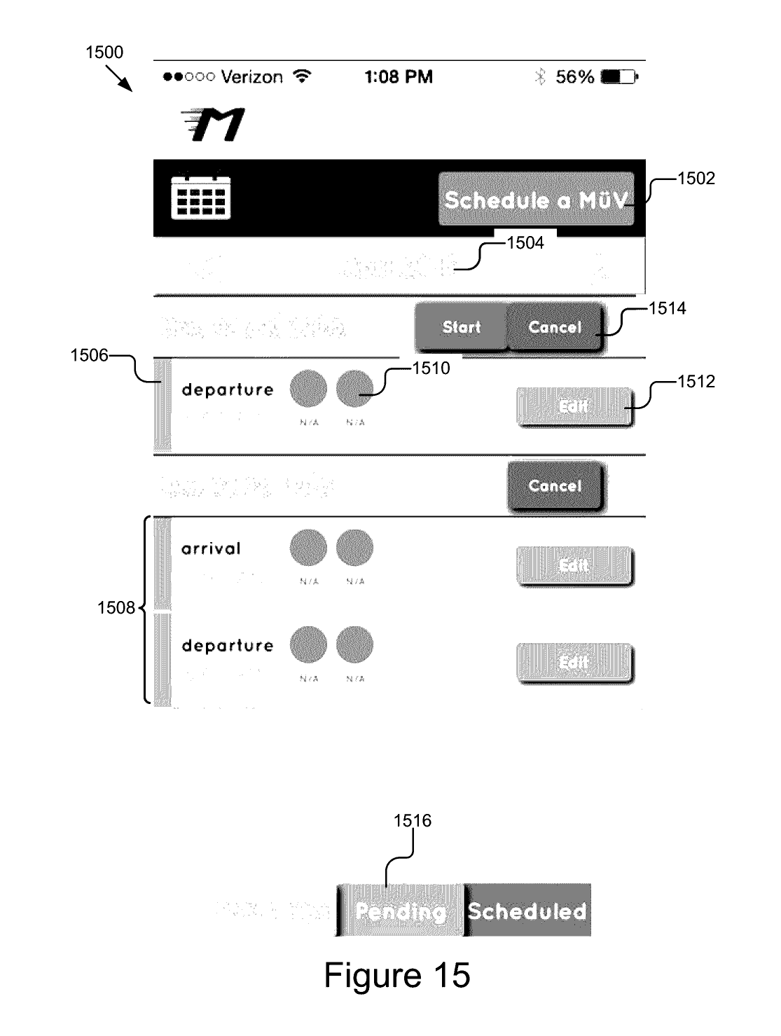

FIG. 15 shows a graphical representation 1500 of another embodiment of the user interface showing an agenda view of scheduled trips. The user interface module 222 may generate an agenda view of scheduled trips by receiving trip information from the matching module 218. In the embodiment, a scheduling button 1502 allows a user to schedule a new trip. A calendar button 1504 allows a user to view a specific period of dates. In the example, a one-way trip 1506 and a round trip 1508 are shown with their corresponding arrival and departure times. A graphical icon indicating available seats 1510 is displayed for each of the trips (e.g., vehicle capacity). In some embodiments, the graphical icon 1510 may display an empty icon when the seats are empty and when the seat fills the graphical icon 1510 may be replaced with a user profile image or some other graphical icon denoting the seat is filled. In some embodiments, once the seat is filled, the graphical icon 1510 displays an image of the specific passenger and the image becomes a selectable button that may be selected to view the specific passenger's profile information. An edit button 1512 is displayed for each trip allowing a user 130 to change various trip details and parameters. A start and/or cancel button 1514 allows a driver to start a trip or cancel a trip. A history tab 1516 is displayed that allows a user to view past trips, pending trips that have not been filled with passengers, and/or scheduled trips.

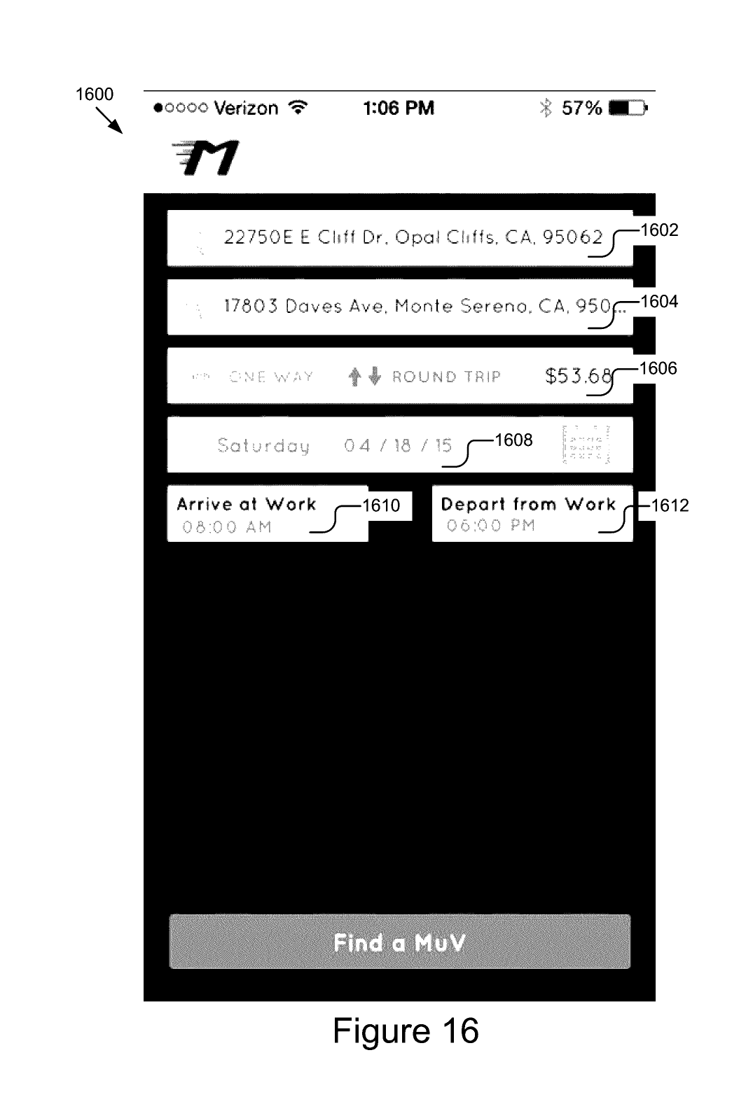

FIG. 16 shows a graphical representation 1600 of another embodiment of the user interface showing a passenger request. The user interface module 222 may generate a user interface for a user 130 to enter a passenger request. The trip details may include a pickup location 1602, a drop off location 1604, a one way or round trip designation including a total fare 1606, a date 1608, an arrival time 1610, and a departure time 1612.

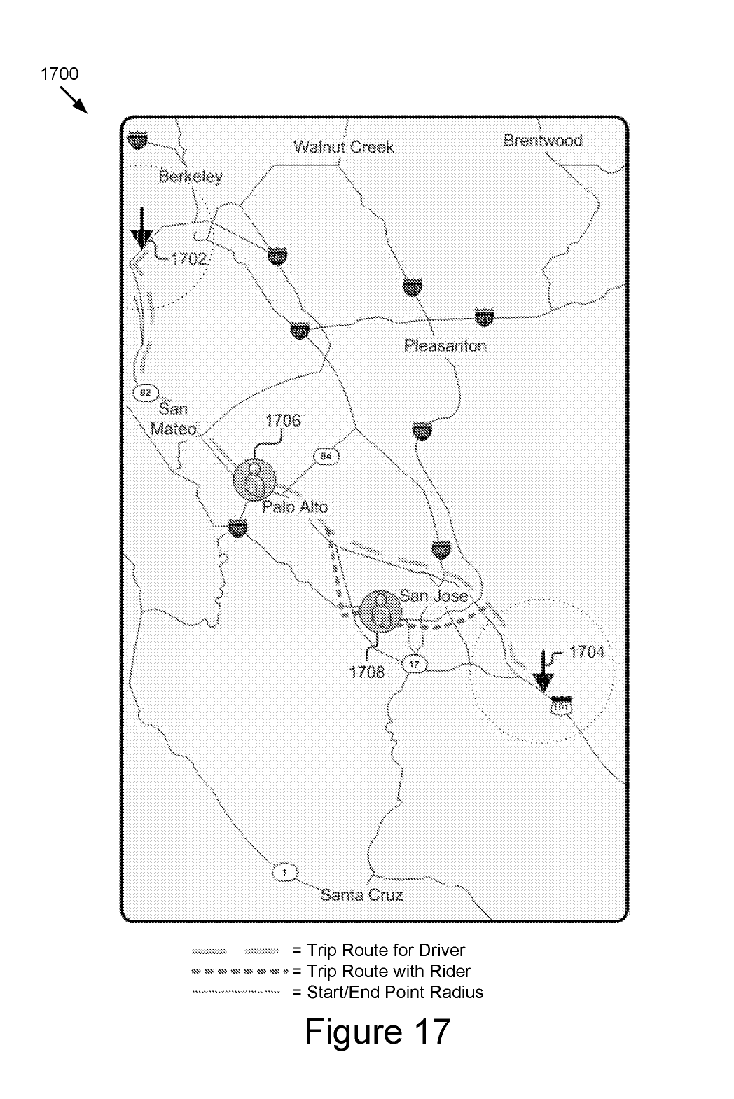

FIG. 17 shows a graphical representation 1700 of another embodiment of the user interface showing a mapping of the trip. The user interface module 222 may generate a user interface to display the trip mapping. The trip mapping may include the start location 1702, the end location 1704, the pickup location 1706, and the drop off location 1708. In some embodiments, the trip mapping may also include a visual display of the driver route and the passenger route and additional miles added by detouring to the passenger route.

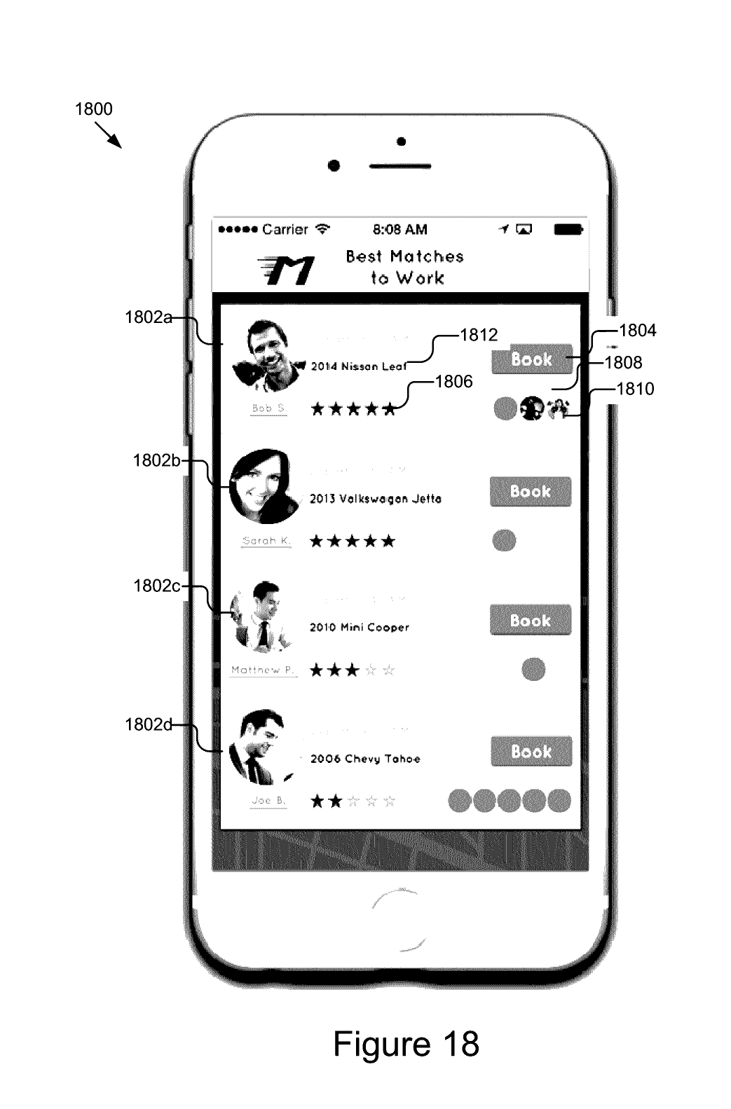

FIG. 18 shows a graphical representation of another embodiment of the user interface showing ride matches. The user interface module 222 may generate a user interface showing the list of ride matches 1802. The list of ride matches 1802 may each display a selectable button to book a trip 1804, an average rating of the driver 1806, an estimated cost of the trip 1808, and/or a graphical icon 1810 of available seats. The graphical icon 1810 indicates vehicle capacity and may optionally be a selectable button to view specific passenger user profiles and/or specific seat assignments in vehicle. The ride matches may also include a vehicle type 1812. In some embodiments, the vehicle type may be limited to personal vehicles, while in further embodiments the vehicle types may be expanded to include vehicles, carpools, vanpools, public transportation, etc.

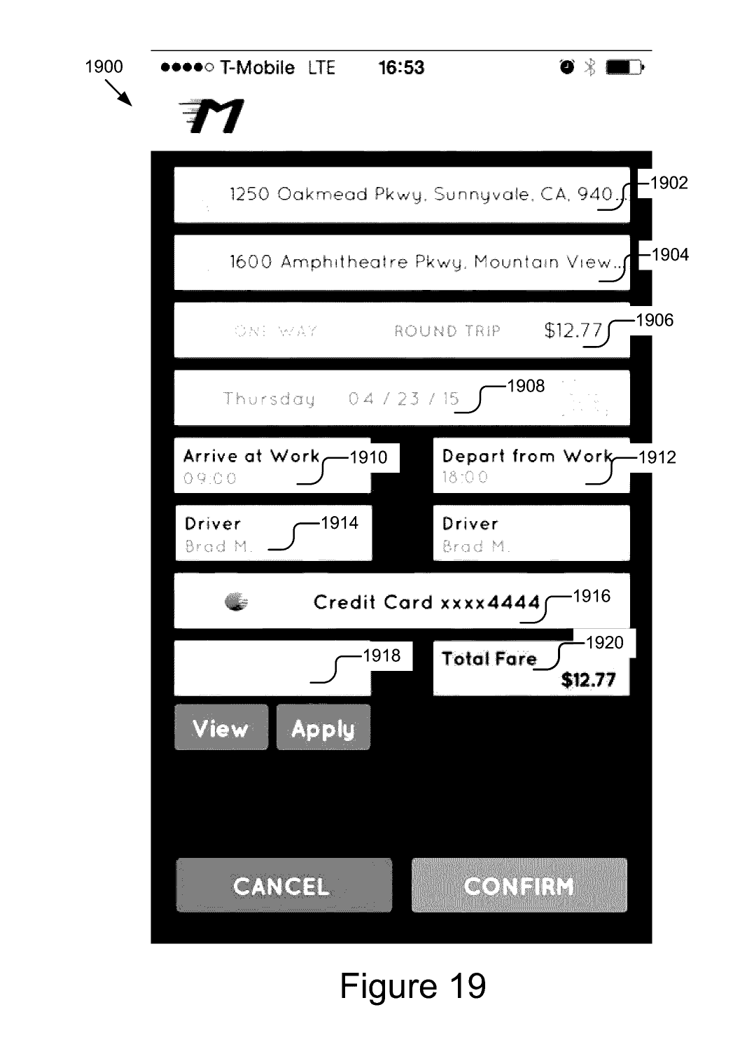

FIG. 19 shows a graphical representation of another embodiment of the user interface showing trip details. The user interface module 222 may generate a user interface for a user 130 to book a trip after the ride match. The trip details may include a pickup location 1902, a drop off location 1904, a round trip designation including a total fare 1906, a date 1908, an arrival time 1910, a departure time 1912, a driver 1914 for the arrival time 1910 and departure time 1912, a payment method 1916, a coupon option 1918, and a total cost 1920.

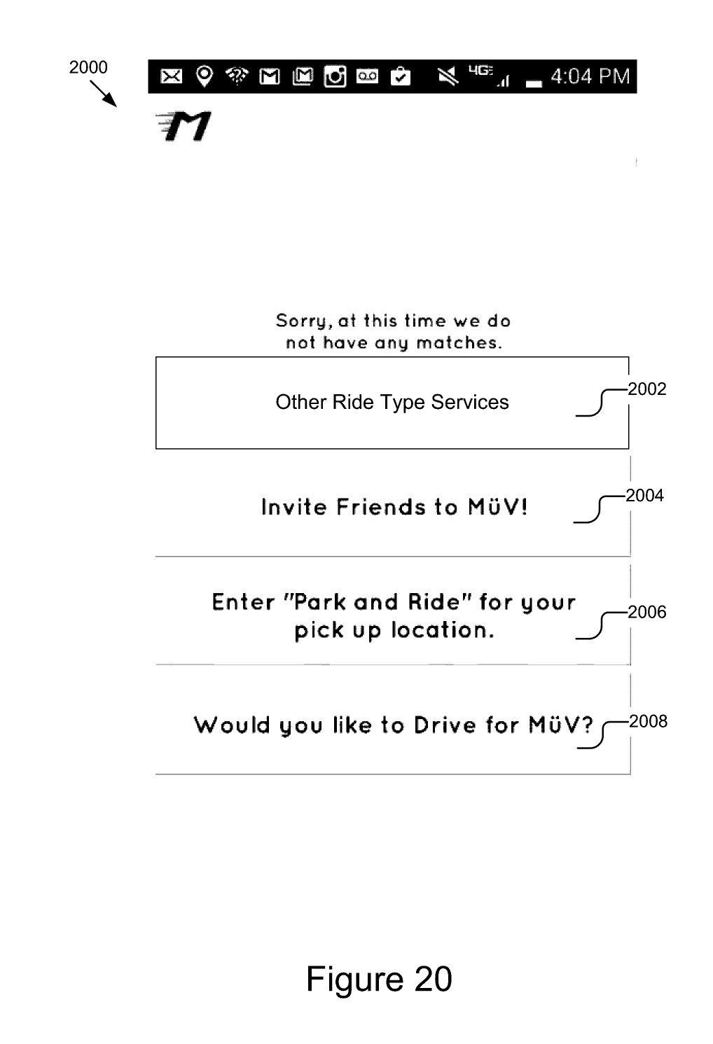

FIG. 20 shows a graphical representation 2000 of another embodiment of the user interface showing no driver matches. The user interface module 222 may generate a user interface displaying that no ride matches happened based on the current trip details and parameters. The user interface module 222 may additionally provide options for the user to adjust the trip details and parameters to expand the comparison options. The user interface module 222 may provide a ride type button 2002 for a user 130 to select to change the ride type parameter or view other ride type options. Additionally, the user interface module 22 may link to third party applications that provide additional transportation services/options to be displayed to the user. The user interface module 222 may provide an invitation button 2004 for a user 130 to select to invite others to create profiles and become users 130. The user interface module 222 may provide a park and ride button 2006 showing potential pickup locations that a passenger may select. Alternatively, a hot spot button may be provided allowing a passenger and or driver to select hot spots for pickup locations. The user interface module 222 may provide a driver application button 2008 allowing a user 130 to apply to become a driver. In some embodiments, a user 130 must apply and be approved by an administrator before the user 130 can fill out a driver profile.

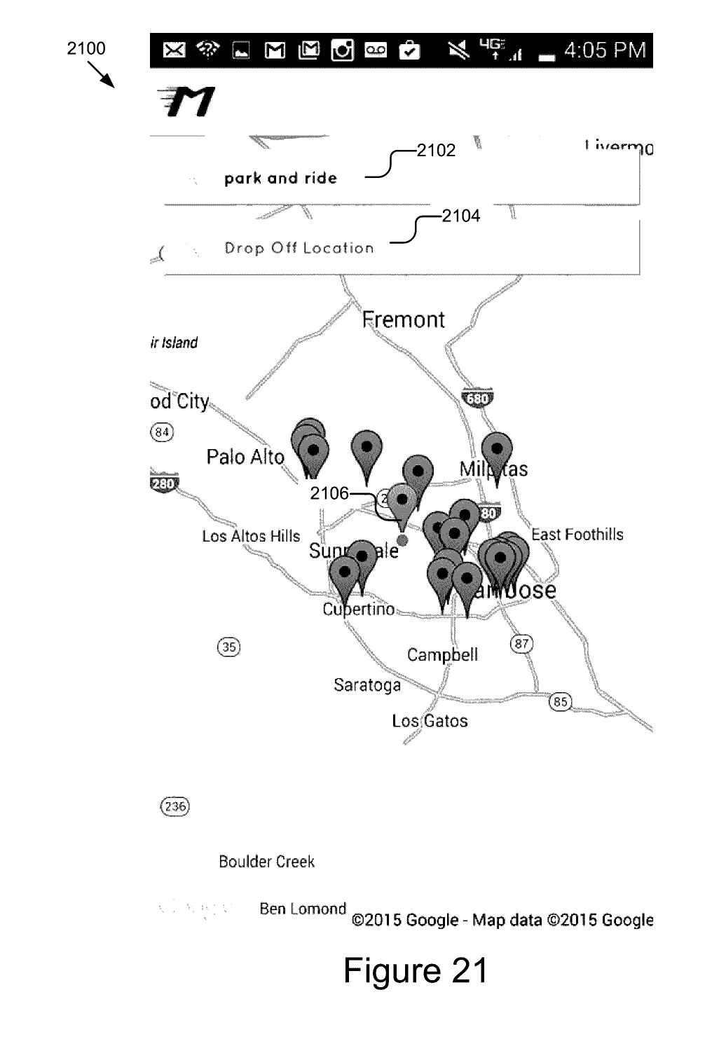

FIG. 21 shows a graphical representation 2100 of another embodiment of the user interface showing pickup locations. The user interface module 222 may display a mapping of park and ride locations. In some embodiments, the user interface module 222 may display alternative pickup locations 2102, drop off locations 2104, or alternatively hot spot locations near a user 130's current location 2106.

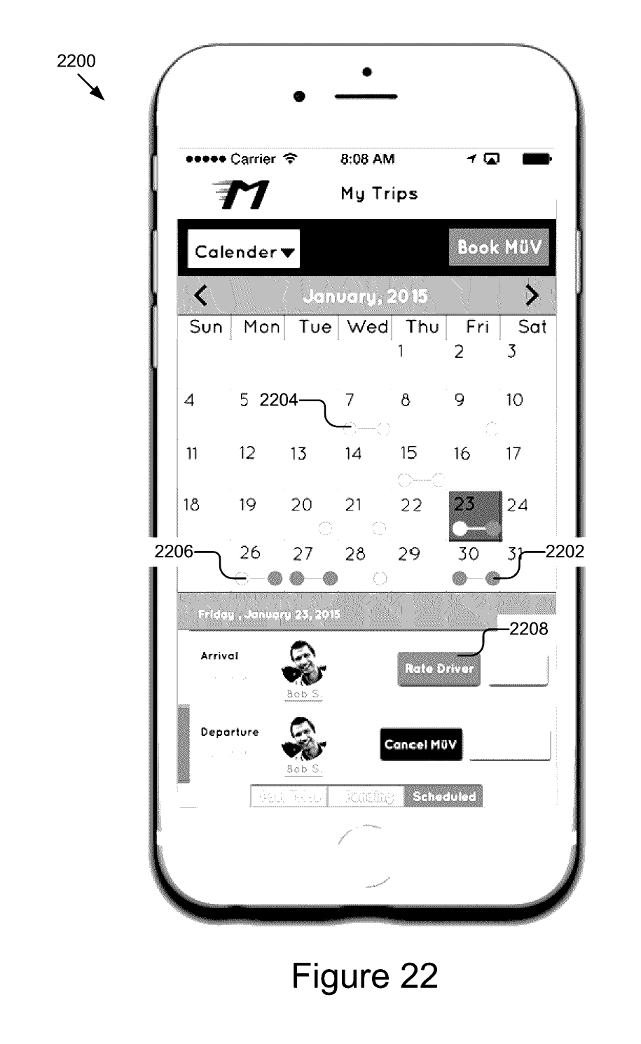

FIG. 22 shows a graphical representation 2200 of another embodiment of the user interface showing a calendar of trips. The user interface module 222 may display in a graphical user interface, a calendar showing scheduled trips 2202, past trips 2204, and pending trips 2206 in different graphical icons. In some embodiments, the user interface module 222 may include a rating button 2208 to rate drivers from past trips.

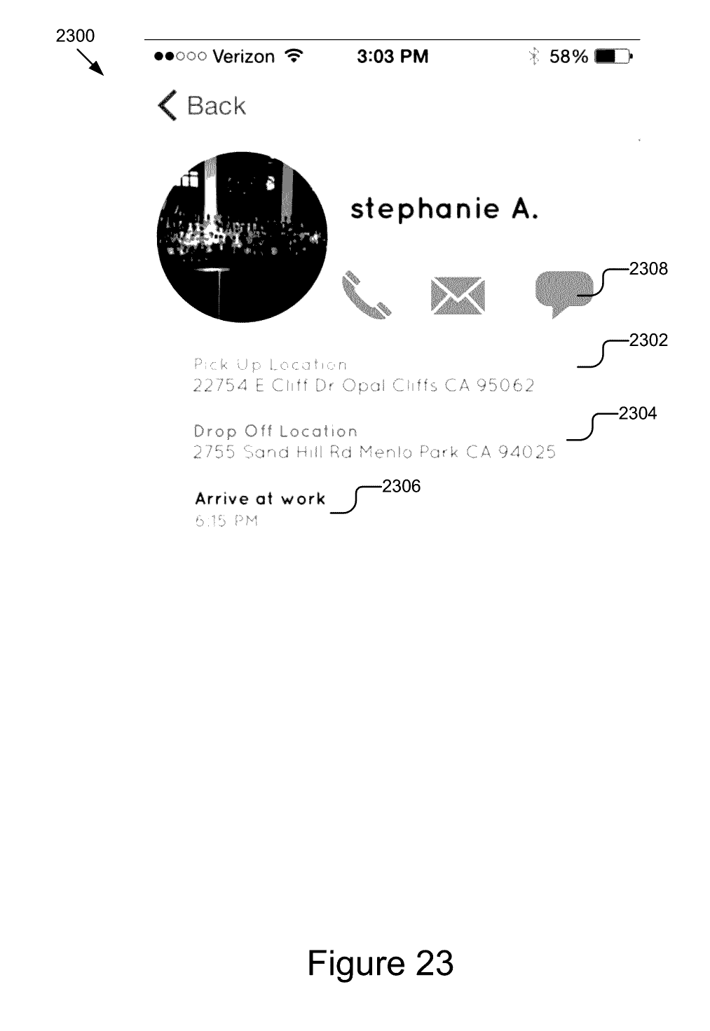

FIG. 23 shows a graphical representation 2300 of another embodiment of the user interface showing passenger request details. The passenger request may include the pick-up location 2302, drop off location 2304, and/or arrival time 2306. The user interface module 222 may display the passenger request details in a user interface for viewing by the passenger and/or the driver. The user interface module 222 may also include various contact option buttons 2308 for a driver to contact a passenger by selecting the contact option button 2308.

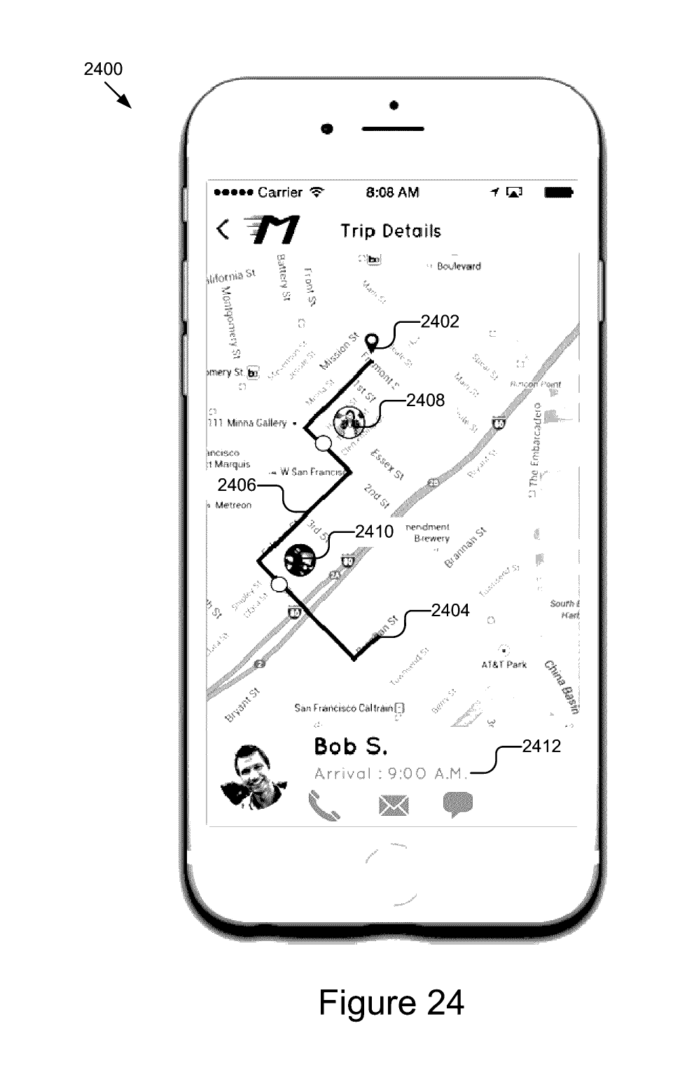

FIG. 24 shows a graphical representation 2400 of another embodiment of the user interface showing a mapping of the trip with an estimated arrival time. The user interface module 222 may include in the mapping a stop location 2402, a current vehicle location 2404, a driver route 2406, a first passenger pickup location 2410, a second passenger pickup location 2408, and an estimated arrival time 2412.

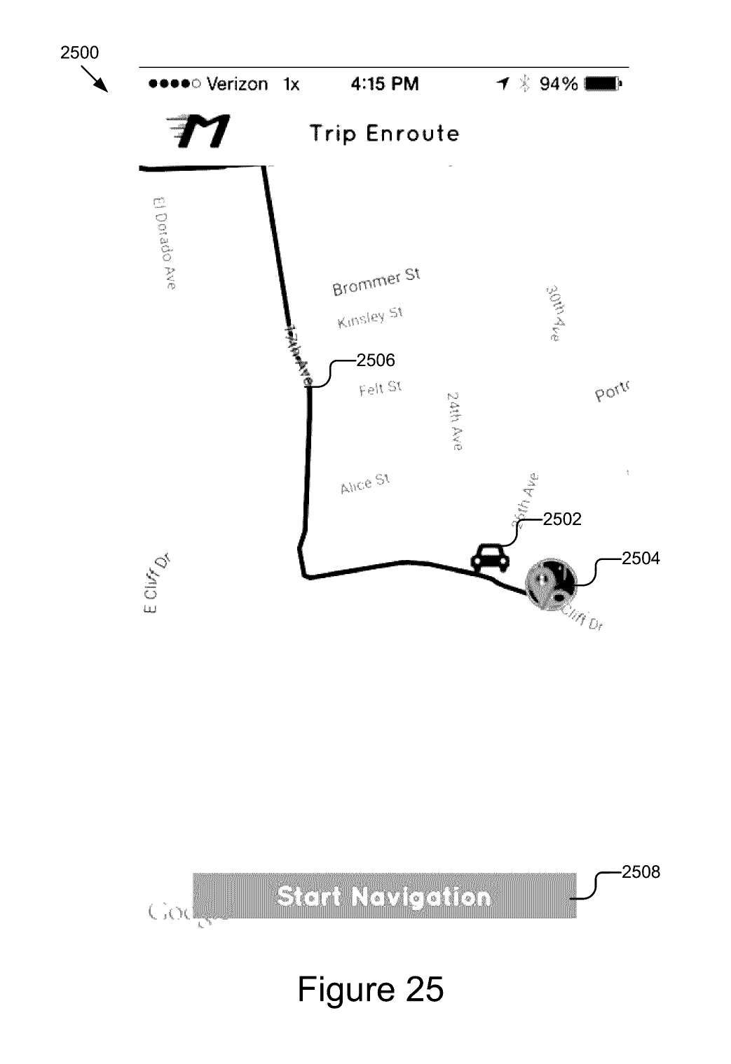

FIG. 25 shows a graphical representation 2500 of another embodiment of the user interface showing a mapping of the trip with a vehicle location indicator. The user interface module 222 may include in the mapping a vehicle location icon 2502 displaying the current vehicle location, a start location 2504, a driver route 2506, and/or a start navigation button 2508 that allows the driver to star monitoring the vehicle location and providing the vehicle location to the passengers as the vehicle location icon 2502.

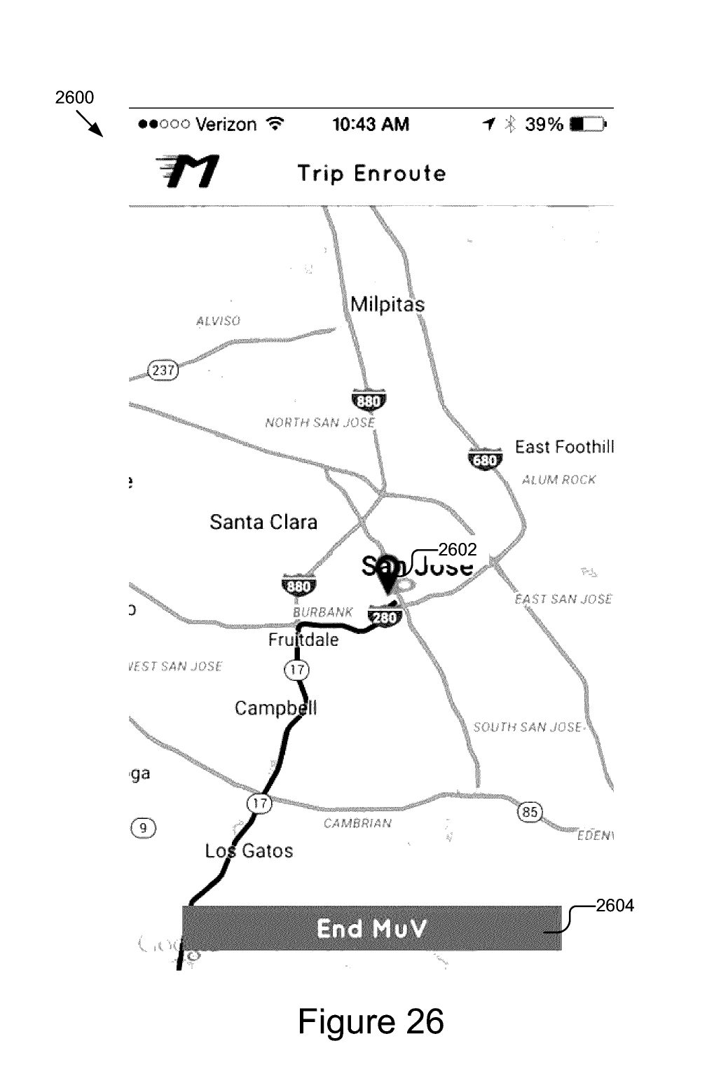

FIG. 26 shows a graphical representation 2600 of another embodiment of the user interface showing a mapping of the trip. The user interface module 222 may include a user interface displaying a stop location 2602 along the driver route and may optionally provide an end trip button 2604 to the driver. When the driver selects the end trip button 2604 the vehicle location monitoring is stopped and passengers may be charged for the trip based on payment information. In further embodiments, in response to the passengers being charged for the trip, passengers may receive a receipt of the trip and a notification to rate their driver.

A system and method for performing ridesharing has been described. In the above description, for purposes of explanation, numerous specific details are set forth in order to provide a thorough understanding of the techniques introduced above. It will be apparent, however, to one skilled in the art that the techniques can be practiced without these specific details. In other instances, structures and devices are shown in block diagram form in order to avoid obscuring the description and for ease of understanding. For example, the techniques are described in one embodiment above primarily with reference to software and particular hardware. However, the present invention applies to any type of computing system that can receive data and commands, and present information as part of any peripheral devices providing services.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some portions of the detailed descriptions described above are presented in terms of algorithms and symbolic representations of operations on data bits within a computer memory. These algorithmic descriptions and representations are, in some circumstances, used by those skilled in the data processing arts to convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing”, “computing”, “calculating”, “determining”, “displaying”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The techniques also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus or software communication mechanism.

Some embodiments can take the form of an entirely hardware embodiment, an entirely software embodiment or an embodiment containing both hardware and software elements. One embodiment is implemented in software, which includes but is not limited to firmware, resident software, microcode, etc.

Furthermore, some embodiments can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code can include at least one processor coupled directly or indirectly to memory elements through a system bus or software communication mechanism. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the techniques are not described with reference to any particular programming language. It will be appreciated that a variety of programming languages may be used to implement the teachings of the various embodiments as described herein.

The foregoing description of the embodiments has been presented for the purposes of illustration and description. It is not intended to be exhaustive or to limit the specification to the precise form disclosed. Many modifications and variations are possible in light of the above teaching. It is intended that the scope of the embodiments be limited not by this detailed description, but rather by the claims of this application. As will be understood by those familiar with the art, the examples may be embodied in other specific forms without departing from the spirit or essential characteristics thereof. Likewise, the particular naming and division of the modules, routines, features, attributes, methodologies and other aspects are not mandatory or significant, and the mechanisms that implement the description or its features may have different names, divisions and/or formats. Furthermore, as will be apparent to one of ordinary skill in the relevant art, the modules, routines, features, attributes, methodologies and other aspects of the specification can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the specification is in no way limited to embodiment in any specific programming language, or for any specific operating system or environment. Accordingly, the disclosure is intended to be illustrative, but not limiting, of the scope of the specification, which is set forth in the following claims.

What is claimed is:

1. A computer implemented method comprising:
identifying a plurality of users as a group;
receiving profile information for the plurality of users to identify a driver and a passenger;
receiving trip details from the driver;
receiving a passenger request from the passenger;
performing a ride match to match the driver and the passenger based on the trip details and the passenger request; and
providing a result of the ride match to the driver and the passenger.

2. The method of claim 1, wherein the trip details include one of a start location, a stop location, a round trip designation, a date, an arrival time, a departure time, and a hot spot location.

3. The method of claim 2, further comprising:
determining a driver route using the start location and the stop location;
determining a route distance based on the driver route; and
storing the route distance, the driver route, and the trip details in a database.

4. The method of claim 1, wherein the passenger request includes one of a pickup location, a drop off location, a round trip designation, a date, an arrival time, and a departure time.

5. The method of claim 4, further comprising:
determining a passenger route using the pickup location and the drop off location; and
storing the passenger route in a database.

6. The method of claim 1, further comprising:
identifying a driver parameter associated with the driver;
identifying a passenger parameter associated with the passenger; and
performing the ride match includes determining that the driver parameter and passenger parameter are satisfied.

7. The method of claim 1, further comprising:
receiving an indication to start a trip from the driver;
logging a start time in response to receiving the indication to start the trip;
monitoring a vehicle location of a vehicle associated with the trip;
visually mapping the vehicle location in a user interface; and
providing the visual mapping of the vehicle location to the passenger.

8. A computer implemented method comprising:
receiving profile information from a plurality of users associated with a group;
receiving a driver route from a first user of the plurality of users, the driver route including a driver parameter;
receiving a passenger request from a second user of the plurality of users, the passenger request including a pickup location;
determining a ride match between the driver route and the passenger request based on the pickup location and the driver parameter, wherein determining the ride match includes comparing the driver route to the pickup location and determining that the driver parameter is satisfied based on the driver route and the pickup location; and
providing the ride match to the first user associated with the driver route and the second user associated with the pickup location.

9. The method of claim 8, wherein the passenger requests includes a passenger parameter.

10. The method of claim 9, wherein determining the ride match further includes determining that the passenger parameter is satisfied based on the driver route and the pickup location.

11. The method of claim 8, further comprising:
determining a vehicle capacity for a vehicle associated with the first user; and
displaying the vehicle capacity in a user interface.

12. The method of claim 11, wherein the vehicle capacity is displayed as a selectable icon representing a seat in the vehicle and linked to a passenger profile associated with the seat.

13. A system comprising:
a processor; and
a memory storing instructions that, when executed, cause the system to perform instructions including:
identifying a plurality of users as a group;
receiving profile information for the plurality of users to identify a driver and a passenger;
receiving trip details from the driver;
receiving a passenger request from the passenger;
performing a ride match to match the driver and the passenger based on the trip details and the passenger request; and
providing a result of the ride match to the driver and the passenger.

14. The system of claim 13, wherein the trip details include one of a start location, a stop location, a round trip designation, a date, an arrival time, a departure time, and a hot spot location.

15. The system of claim 14, wherein the instructions further include:
determining a driver route using the start location and the stop location;
determining a route distance based on the driver route; and
storing the route distance, the driver route, and the trip details in a database.

16. The system of claim 13, wherein the passenger request includes one of a pickup location, a drop off location, a round trip designation, a date, an arrival time, and a departure time.

17. The system of claim 16, wherein the instructions further include:
determining a passenger route using the pickup location and the drop off location; and
storing the passenger route in a database.

18. The system of claim 16, wherein the instructions further include:
identifying a driver parameter associated with the driver;
identifying a passenger parameter associated with the passenger; and
performing the ride match includes determining that the driver parameter and the passenger parameter are satisfied.

19. The system of claim 13, wherein the instructions further include:
receiving an indication to start a trip from the driver;
logging a start time in response to receiving the indication to start the trip;
monitoring a vehicle location of a vehicle associated with the driver;
visually mapping the vehicle location in a user interface; and
providing the mapping of the vehicle location to the passenger.

20. A system of claim 13, wherein performing the ride match to match the driver and the passenger further includes:
identifying a passenger parameter associated with the passenger;
identifying a driver parameter associated with the driver; and
determining that the passenger parameter and the driver parameter are satisfied based on the trip details and the passenger request.
